(19) United States
(12) Patent Application Publication
(10) Pub. No.: US 2020/0354231 A1
(43) Pub. Date: Nov. 12, 2020

(54) FUNCTIONAL UNIT FOR BATHROOM

(71) Applicant: LIXIL Corporation, Tokyo (JP)

(72) Inventors: Shunji OTA, Tokyo (JP); Kouji NAKATA, Tokyo (JP); Mayuko OUCHI, Tokyo (JP); Yuichiro KOMATSU, Tokyo (JP); Naoya TAMURA, Tokyo (JP); Wakaba HYODO, Tokyo (JP); Shinichi YAGI, Tokyo (JP); Touichirou MATSUURA, Tokyo (JP); Kazuhiro SATO, Tokyo (JP); Takashi HAGIWARA, Tokyo (JP); Shinya SAKATA, Tokyo (JP)

(73) Assignee: LIXIL Corporation, Tokyo (JP)

(21) Appl. No.: 16/760,435

(22) PCT Filed: Oct. 29, 2018
(86) PCT No.: PCT/JP2018/040031

§ 371 Date: Apr. 29, 2020

(30) Foreign Application Priority Data
Oct. 31, 2017 (JP) 2017-211128
Oct. 31, 2017 (JP) 2017-211129
Aug. 31, 2018 (JP) 2018-163724

(51) Int. Cl. C02F 1/00; E03C 1/06

(52) U.S. Cl. CPC C02F 1/003; C02F 2103/02; E03C 2201/30; E03C 1/06

(57) ABSTRACT

Provided is a functional unit for a bathroom that includes a functional component for a bathroom, separated from a water faucet device and fixed to a bathroom wall part; and a reforming unit that is formed integrally with the functional component for a bathroom and that includes a cartridge capable of reforming raw water flowing through a water supply passage from the water faucet device to a water discharge device. The reforming unit includes a casing that houses the cartridge, and the casing is detachably connected to the functional component.

### CROSS-REFERENCE TO RELATED APPLICATIONS

This application is a national stage application under 35 USC 371 of International Application No. PCT/JP2018/040031, filed Oct. 29, 2018, which claims the priority of Japanese Application No. 2018-163724, filed Aug. 31, 2018, Japanese Application No. 2017-211128, filed Oct. 31, 2017, and Japanese Application No. 2017-211129, filed Oct. 31, 2017, the entire contents of each of which are incorporated herein by reference.

### FIELD OF THE DISCLOSURE

The present invention relates to a functional unit for a bathroom, provided with a functional component for a bathroom.

### BACKGROUND OF THE DISCLOSURE

In order to purify water supplied to a water discharge device, such as a shower head, a water purification cartridge is sometimes built into a water supply passage through which water is supplied to the water discharge device. For example, Patent Literature 1 discloses a hot and cold water feeder in which a water purification cartridge is built into a slide bar (bar member) along which a shower hook can be slid. In the hot and cold water feeder, the slide bar that houses the water purification cartridge is directly fixed to a bathroom wall part.

Patent Literature 1 Japanese Unexamined Patent Application Publication No. 2003-174977

### SUMMARY OF THE DISCLOSURE

The inventors have considered building a cartridge, such as a water purification cartridge, into a functional component for a bathroom, such as a slide bar. In the process of such consideration, the inventors have recognized that there is room for improvement in the technology disclosed in Patent Literature 1, in terms of improving flexibility for handling replacement of the cartridge.

The present disclosure has been made in view of such a problem, and a purpose thereof is to provide a technology for improving flexibility for handling cartridge replacement.

In the technology disclosed in Patent Literature 1, there is a problem with the cartridge within the bar member that limits the shape of the bar member. This is not limited to the case where a cartridge is built into a bar member and is a problem generally in common when a cartridge is built into a receiving member for receiving a load of a bathroom item or a bathing person, so that improvement therefor is desired.

The present disclosure has been made in view of such a problem, and a purpose thereof is to provide a technology for improving flexibility in the shape of the receiving member.

The inventors have considered building a raw water reforming device, which reforms raw water, into a functional component for a bathroom, such as a slide bar. In the process of such consideration, the inventors have recognized that there is room for improvement in the technology disclosed in Patent Literature 1, in terms of costs of the raw water reforming device.

The present disclosure has been made in view of such a situation, and a purpose thereof is to provide a technology for enabling cost reduction of a functional unit for a bathroom provided with a raw water reforming device.

To solve the aforementioned problems, some embodiments include a functional unit for a bathroom. The functional unit for a bathroom includes: a functional component for a bathroom, separated from a water faucet device and fixed to a bathroom wall part; and a reforming unit that is formed integrally with the functional component and that includes a cartridge capable of reforming raw water flowing through a water supply passage from the water faucet device to a water discharge device. The reforming unit includes a casing that houses the cartridge, and the casing is detachably connected to the functional component.

In this mode, when the cartridge is replaced, the casing can also be replaced. Therefore, flexibility for handling replacement of the cartridge can be improved.

To solve the aforementioned problems, some embodiments also include a functional unit for a bathroom. The functional unit for a bathroom includes: a functional component for a bathroom, separated from a water faucet device and fixed to a bathroom wall part; and a reforming unit that is formed integrally with the functional component and that includes a cartridge capable of reforming raw water flowing through a water supply passage from the water faucet device to a water discharge device. The functional component for a bathroom includes a receiving member that receives a load of a bathroom item or a bathing person, and the cartridge is disposed outside the receiving member.

In this mode, since the cartridge is not disposed within the receiving member, a situation where the shape of the receiving member is limited by the cartridge can be avoided, so that flexibility in the shape of the receiving member can be improved.

To solve the aforementioned problems, some embodiments include a functional unit for a bathroom. The functional unit for a bathroom includes: a support member that is fixed to a bathroom wall part and that supports a functional component for a bathroom; and a raw water reforming device (reforming unit) that reforms raw water and that is provided separately from the support member and fixed to the support member.

This mode provides a technology for enabling cost reduction of a functional unit for a bathroom provided with a raw water reforming device.

Optional combinations of the aforementioned constituting elements, and implementation of the present disclosure, including the constituting elements and expressions, in the form of methods, apparatuses, or systems may also be practiced as additional modes of the present disclosure.

### BRIEF DESCRIPTION OF THE FIGURES

Embodiments will now be described, by way of example only, with reference to the accompanying drawings which are meant to be exemplary, not limiting, and wherein like elements are numbered alike in several Figures, in which:

FIG. 1 is a perspective view of a bathroom unit, according to some embodiments;

FIG. 2 is a configuration diagram of a water path used in the bathroom unit, according to some embodiments;

FIG. 3 is a front view of a functional unit with peripheral structures thereof, according to some embodiments;

FIG. 4 is a side view of part of the functional unit, according to some embodiments;

FIG. 5 is a schematic sectional side view of part of the functional unit, according to some embodiments;

FIG. 6 is a perspective view of part of the functional unit, according to some embodiments;

FIG. 7 is a magnified view of part of a reforming unit, according to some embodiments;

FIG. 8 is a diagram that shows a state where the reforming unit has been detached from a functional component, according to some embodiments;

FIG. 9 is a sectional view that shows a state before the reforming unit is attached to the functional component, according to some embodiments;

FIG. 10 is a magnified view of the peripheral structures of the reforming unit shown in FIG. 3, according to some embodiments;

FIG. 11 is a diagram of a connected part of the functional component viewed from the direction of an arrow Pe shown in FIG. 7, according to some embodiments;

FIG. 12 is a diagram that shows a state during an operation of detaching a casing from the functional component, according to some embodiments;

FIG. 13A is a schematic diagram that shows a position at which a primary side hose is connected to the functional component, according to some embodiments;

FIG. 13B is a schematic diagram that shows a position at which a secondary side hose is connected to the functional component, according to some embodiments;

FIG. 13C is another schematic diagram that shows a position at which a secondary side hose is connected to the functional component, according to some embodiments;

FIG. 13D is yet another schematic diagram that shows a position at which a secondary side hose is connected to the functional component, according to some embodiments;

FIG. 14A is a schematic diagram that shows a position at which the primary side hose is connected to the functional component, according to some embodiments;

FIG. 14B is a schematic diagram that shows a position at which the secondary side hose is connected to the functional component, according to some embodiments;

FIG. 14C is another schematic diagram that shows a position at which the secondary side hose is connected to the functional component, according to some embodiments;

FIG. 14D is yet another schematic diagram that shows a position at which the secondary side hose is connected to the functional component, according to some embodiments;

FIG. 15A is a schematic diagram that shows a position at which the primary side hose is connected to the functional component, according to some embodiments;

FIG. 15B is a schematic diagram that shows a position at which the secondary side hose is connected to the functional component, according to some embodiments;

FIG. 15C is another schematic diagram that shows a position at which the secondary side hose is connected to the functional component, according to some embodiments;

FIG. 16A is a schematic side view of a functional unit, according to some embodiments;

FIG. 16B is another schematic side view of a functional unit, according to some embodiments;

FIG. 17A is a schematic side view of a functional unit, according to some embodiments;

FIG. 17B is another schematic side view of a functional unit, according to some embodiments;

FIG. 18 is a perspective view of a bathroom unit, according to some embodiments;

FIG. 19 is a side view of the functional unit shown in FIG. 18, according to some embodiments;

FIG. 20 is a diagram that shows a water supply passage from a water faucet device to a water discharge device shown in FIG. 18, according to some embodiments;

FIG. 21 is a left side view of a raw water reforming device shown in FIG. 18 and the vicinity thereof, according to some embodiments;

FIG. 22 is a front view of the raw water reforming device shown in FIG. 18 and the vicinity thereof, according to some embodiments;

FIG. 23 is an exploded perspective view of the raw water reforming device shown in FIG. 18 and the vicinity thereof, according to some embodiments;

FIG. 24 is a sectional view taken along line A-A in FIG. 22, according to some embodiments;

FIG. 25 is a sectional view taken along line B-B in FIG. 21, according to some embodiments;

FIG. 26 is a sectional view taken along line C-C in FIG. 21, according to some embodiments;

FIG. 27 is a sectional view taken along line D-D in FIG. 21, according to some embodiments;

FIG. 28 is a sectional view taken along line E-E in FIG. 21, according to some embodiments;

FIG. 29 is a sectional view taken along line F-F in FIG. 21, according to some embodiments;

FIG. 30A is a left side view of a cover, according to some embodiments;

FIG. 30B is a front view of a cover, according to some embodiments;

FIG. 30C is a right side view of a cover, according to some embodiments;

FIG. 30D is a rear view of a cover, according to some embodiments;

FIG. 31 is an exploded perspective view of a second hose connection part and the vicinity thereof, according to some embodiments;

FIG. 32 is a perspective view of the cover shown in FIG. 31, according to some embodiments; and

FIG. 33 is a diagram that shows a cover in a modification, according to some embodiments.

### DETAILED DESCRIPTION OF THE DISCLOSURE

In the following embodiments and modifications, same reference characters denote same constituting elements, and repetitive description will be omitted. Also, in each drawing, part of the constituting elements may be appropriately omitted, or the size of a constituting element may be appropriately enlarged or reduced, for the sake of convenience.

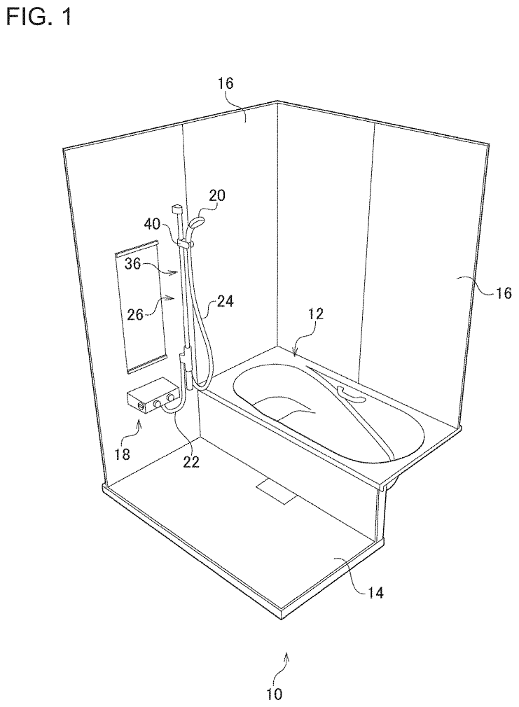

FIG. 1 is a perspective view of a bathroom unit 10, according to some embodiments. The bathroom unit 10 includes a bathtub 12, a washing place floor 14 provided at a position adjacent to the bathtub 12, and multiple bathroom wall parts 16 that define a bathroom space therein. The bathroom unit 10 also includes a water faucet device 18, a water discharge device 20, a primary side hose 22, a secondary side hose 24, and a functional unit 26, which are arranged in the bathroom space.

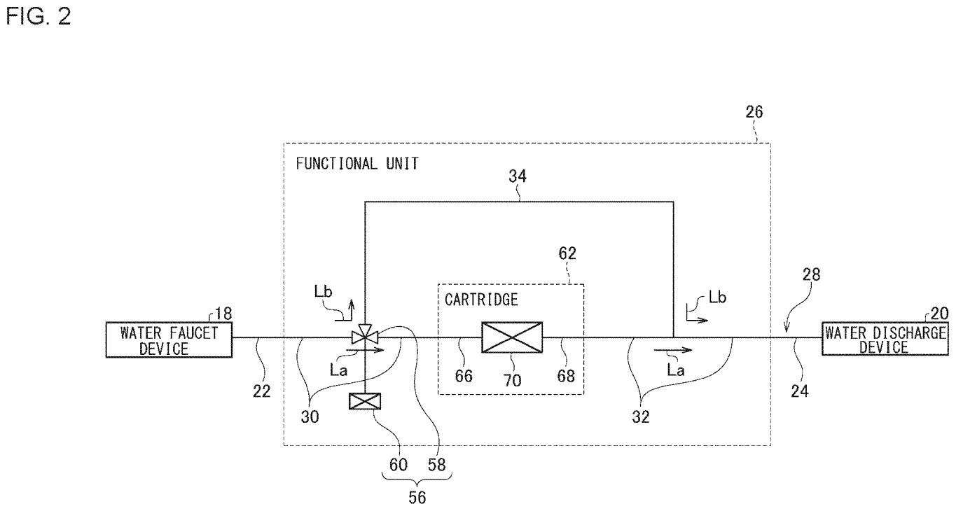

FIG. 2 is a configuration diagram of a water path used in the bathroom unit 10. The bathroom unit 10 includes a water supply passage 28 from the water faucet device 18 to the water discharge device 20. On the water supply passage 28, a cartridge 62 (described later) of the functional unit 26 is provided. The water supply passage 28 includes a primary side water passage 30, a secondary side water passage 32, and a bypass water passage 34, which are provided in the functional unit 26. The primary side water passage 30 is provided on the upstream side of the cartridge 62 and supplied with raw water through the primary side hose 22. The secondary side water passage 32 is provided on the downstream side of the cartridge 62 and supplies raw water or reformed water to the secondary side hose 24. The bypass water passage 34 is diverted around a reformer 70 (described later) of the cartridge 62. The bypass water passage 34 of some embodiments branch off from the primary side water passage 30 at a midway thereof and merges into the secondary side water passage 32 at a midway thereof

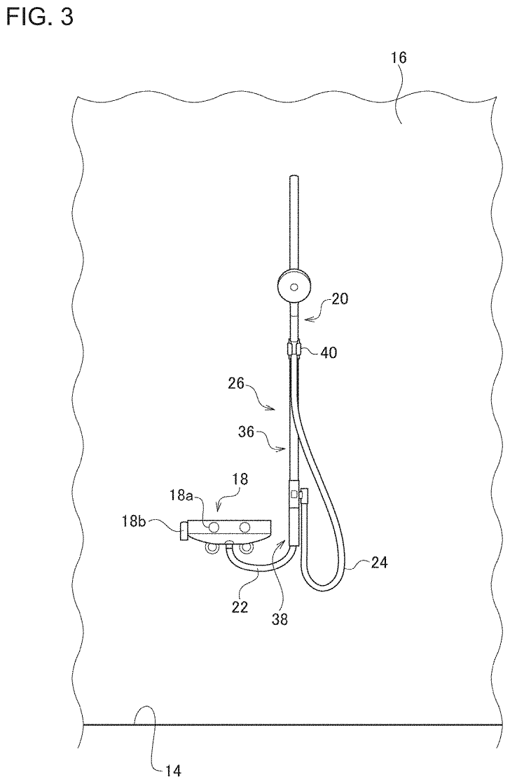

FIG. 3 is a front view of the functional unit 26 with peripheral structures thereof. With the water faucet device 18, the flow rate of water supplied to the water supply passage 28 can be adjusted, through an operation performed by a bathing person on a flow rate operation unit 18a. Also, with the water faucet device 18 of some embodiments, the temperature of the water supplied to the water supply passage 28 can also be adjusted, through an operation performed by a bathing person on a temperature operation unit 18b.

The water discharge device 20 is provided to discharge water supplied through the water supply passage 28. Although the water discharge device 20 of some embodiments is a shower head that is movable with respect to a bathroom wall part 16, it may also be a faucet or the like. The water discharge device 20 of some embodiments is provided to be attachable to or detachable from a shower hook 40 supported by a functional component 36, which will be described later.

The primary side hose 22 and the secondary side hose 24 are flexible. The primary side hose 22 connects the water faucet device 18 and the functional unit 26, and the secondary side hose 24 connects the functional unit 26 and the water discharge device 20.

The functional unit 26 mainly includes the functional component 36 for a bathroom and a reforming unit 38. The functional component 36 is provided to implement a function related to a bathroom. The “function” in some embodiments is receiving a load of a bathroom item 40 or a bathing person. The bathroom item 40 in some embodiments is a shower hook (see also FIG. 1). The functional component 36 of some embodiments is a slide bar that receives the loads of the shower hook and a bathing person and that slidably supports the shower hook. The functional component 36 is separated from the water faucet device 18 and is connected to the water faucet device 18 only via the primary side hose 22 and the bathroom wall part 16.

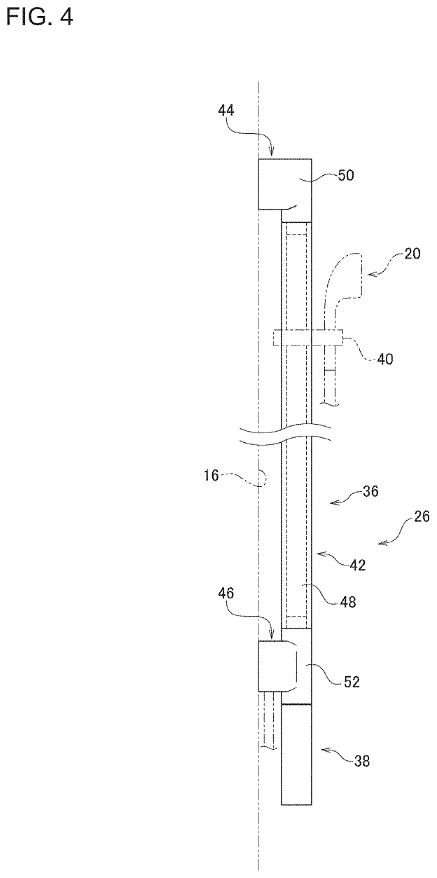

FIG. 4 is a side view of part of the functional unit 26. The functional component 36 of some embodiments includes an elongate part 42 for implementing the function of receiving a load, as described previously, and support parts 44 and 46 for allowing the bathroom wall part 16 to support the elongate part 42. The elongate part 42 of some embodiments is provided such as to extend along a vertical direction. The support parts 44 and 46 are provided such as to protrude from the bathroom wall part 16 and fixed to the bathroom wall part 16 by means of fixtures, such as screws. Accordingly, the functional component 36 is directly fixed to the bathroom wall part 16. The support parts 44 and 46 of some embodiments include an upper support part 44 (a first support part) connected to the elongate part 42, and a lower support part 46 (a second support part) connected to the elongate part 42 at a position different from that where the upper support part 44 is connected, along a longitudinal direction of the elongate part 42.

The functional component 36 of some embodiments includes a bar member 48 that constitutes at least part of the elongate part 42, an upper bracket 50 that constitutes the upper support part 44, and a lower bracket 52 that constitutes the lower support part 46. The brackets 50 and 52 and the bar member 48 are provided separately from each other.

The bar member 48 serves as a receiving member that receives a load of a bathroom item 40 or a bathing person. The load is directly applied by the bathroom item 40 or bathing person to the receiving member. Although the bar member 48 extends linearly in this example, part of the bar member 48 may extend curvedly. Also, although the bar member 48 of this example has a hollow structure in which a hollow part is provided along a longitudinal direction, the bar member 48 may have a solid structure.

The upper bracket 50 and the lower bracket 52 serve as support members for allowing the bathroom wall part 16 to support the receiving member and are directly fixed to the bathroom wall part 16. Accordingly, the receiving member of some embodiments is fixed to the bathroom wall part 16 via the support members.

The bar member 48 is disposed such that at least a middle part thereof is located away from the bathroom wall part 16 with a space in between. The bar member 48 is supported by the bathroom wall part 16 directly or via the support members, at multiple different positions in a longitudinal direction. The bar member 48 of the present embodiment is supported by the bathroom wall part 16 via the support members, at both end parts in a longitudinal direction.

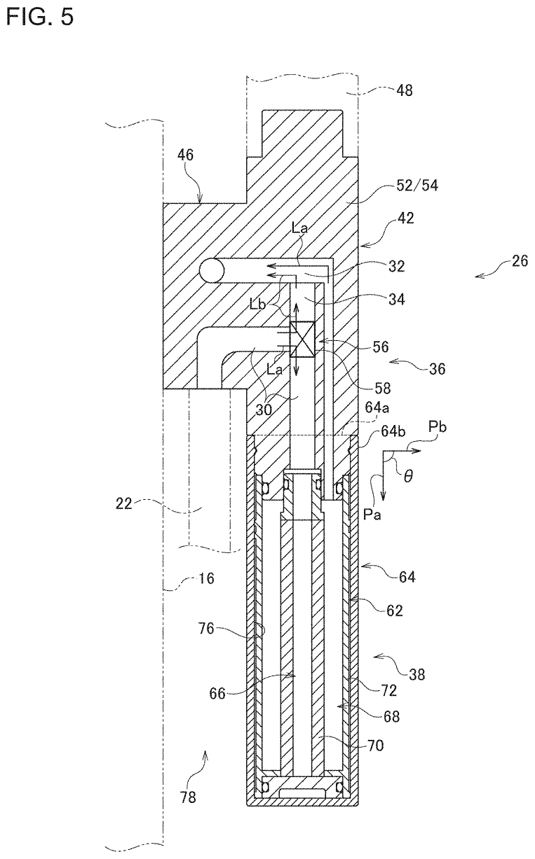

FIG. 5 is a schematic sectional side view of part of the functional unit 26. In the lower bracket 52, the aforementioned primary side water passage 30, secondary side water passage 32, and bypass water passage 34 are formed. The lower bracket 52 serves as a water path formation member 54 in which the water passages 30, 32, and 34 are formed.

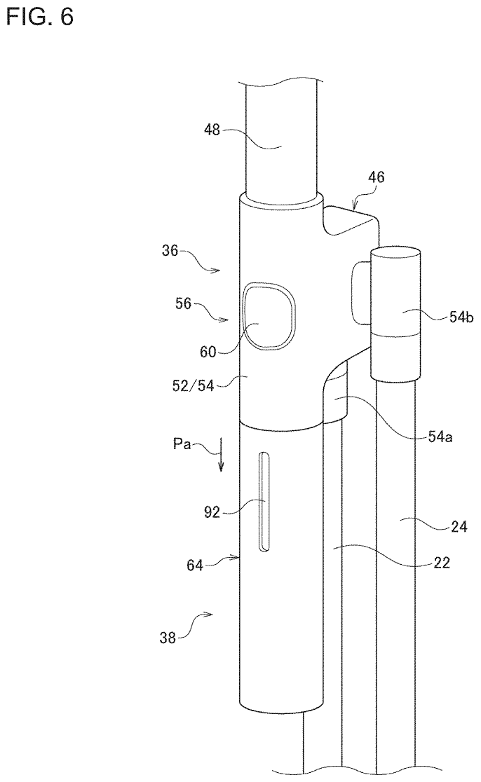

FIG. 6 is a perspective view of part of the functional unit 26. The water path formation member 54 includes a first hose connection part 54a to which the primary side hose 22 is connected, and a second hose connection part 54b to which the secondary side hose 24 is connected. In some embodiments, the first hose connection part 54a is provided on a lower surface part of the lower support part 46 of the functional component 36, and the second hose connection part 54b is provided on a side surface part of the lower support part 46.

As shown in FIGS. 2 and 5, the functional component 36 includes a water path switching mechanism 56 built into the water path formation member 54. The water path switching mechanism 56 is provided to switch an intended route, to which the raw water from the water faucet device 18 is transmitted through the primary side water passage 30, between a reformed water supply route and a raw water supply route. The reformed water supply route of some embodiments is a route that follows arrows La through the primary side water passage 30, the reformer 70 of the cartridge 62, and the secondary side water passage 32. Through the reformed water supply route, reformed water produced in the reformer 70 of the cartridge 62 can be supplied to the water discharge device 20. The raw water supply route of some embodiments is a route that follows arrows Lb through the primary side water passage 30, the bypass water passage 34, and the secondary side water passage 32. Through the raw water supply route, the raw water transmitted from the water faucet device 18 can be supplied to the water discharge device 20.

The water path switching mechanism 56 includes a switching valve 58, and an operation member 60 operated to switch the intended route of raw water by means of the switching valve 58. The switching valve 58 is a three-way valve or the like, and the operation member 60 is a push switch, a rotating handle, or the like.

The reforming unit 38 is formed integrally with the functional component 36 and includes the cartridge 62 and a casing 64. The reforming unit 38 of some embodiments has a feature by which the casing 64 is provided such as to protrude from the functional component 36. In the following, a protruding direction of the casing 64 will be referred to as a protruding direction Pa.

The cartridge 62 is disposed outside a receiving member 48. The cartridge 62 of some embodiments is disposed also outside the water path formation member 54.

The cartridge 62 can reform the raw water flowing through the water supply passage 28, thereby producing reformed water. The “reforming” in the present specification means changing the composition or properties of raw water by removing or adding a specific component from or to the raw water through a physical change or a chemical change. The reforming through a physical change may be removing a specific component by adsorption or adding a specific component by dissolution, for example. The reforming through a chemical change may be removing or adding a specific component by a chemical reaction or electrolysis, for example. The cartridge 62 of the some embodiments can purify the raw water by removing residual chlorine, thereby producing purified water as reformed water.

As shown in FIGS. 2 and 5, the cartridge 62 of some embodiments has an elongate shape extending in the protruding direction Pa of the casing 64. The cartridge 62 includes a primary side internal water path 66, a secondary side internal water path 68, the reformer 70, and a housing 72.

The primary side internal water path 66 is provided to receive water transmitted from an upstream side water path located on the upstream side of the cartridge 62 in the water supply passage 28. The upstream side water path in some embodiments is the primary side water passage 30 in the functional component 36. The secondary side internal water path 68 is provided to transmit water to a downstream side water path located on the downstream side of the cartridge 62 in the water supply passage 28. The downstream side water path in some embodiments is the secondary side water passage 32 in the functional component 36. The primary side internal water path 66 and the secondary side internal water path 68 are provided within the housing 72, and the housing 72 houses the reformer 70 therein.

Through the reformer 70, the raw water transmitted to the primary side internal water path 66 flows to the secondary side internal water path 68. The reformer 70 of some embodiments separates the primary side internal water path 66 from the secondary side internal water path 68 and is made of a material having water permeability and fixed shape properties. By allowing raw water to flow from the primary side internal water path 66 through the reformer 70 to the secondary side internal water path 68, the raw water can be reformed. The reformer 70 of the present embodiment is made of a material that enables purification of raw water. The material may be activated carbon, a hollow fiber membrane, calcium sulfite, or ascorbic acid, for example.

The reformer 70 of some embodiments has a cylindrical shape, and the primary side internal water path 66 is formed within the reformer 70. The housing 72 of some embodiments also has a cylindrical shape, and the secondary side internal water path 68 is formed between the housing 72 and the reformer 70. On a base end part of the reformer 70 in some embodiments, a joint member 74 of a cylindrical shape is provided, and the primary side internal water path 66 is formed also within the joint member 74.

The casing 64 includes a housing space 76, in which the cartridge 62 is housed, to protect the cartridge 62. The casing 64 forms an outermost surface of the reforming unit 38 exposed to the bathroom space outside the casing 64. The casing 64 of some embodiments has a cylindrical shape extending in the protruding direction Pa of the casing 64, and particularly has a bottomed cylindrical shape of which the bottom part is constituted by the leading end part of the casing 64, and an opening 64a is provided on the base end part. The opening 64a of the casing 64 in some embodiments opens upward. The cartridge 62 is fitted into the housing space 76 in the casing 64.

The casing 64 is not directly fixed to the bathroom wall part 16 and is provided away from the bathroom wall part 16 with a space 78 in between. The size of the space 78 is set such that a hand of a worker can be placed therein, which may be 3 centimeters or greater, for example.

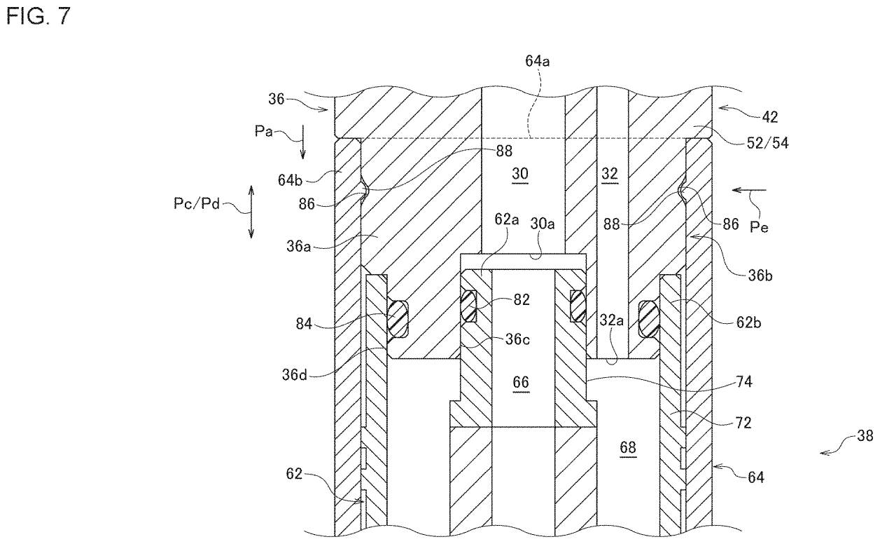

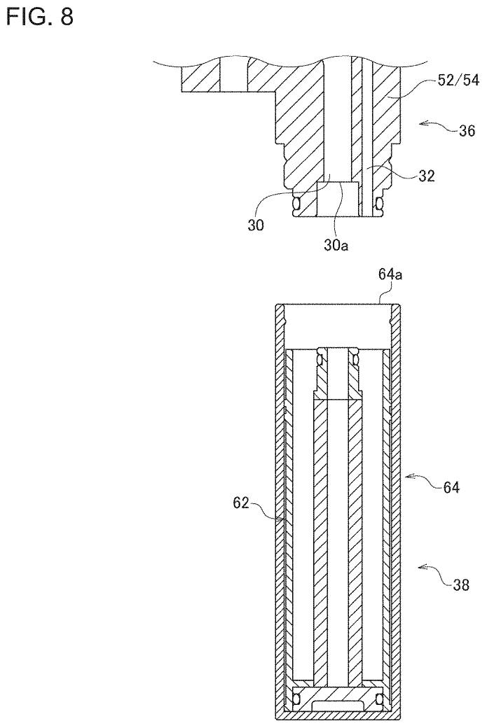

FIG. 7 is a magnified view of part of the reforming unit 38. FIG. 8 is a diagram that shows a state where the reforming unit 38 has been detached from the functional component 36. The casing 64 includes a connection part 64b that is detachably connected to a connected part 36a of the functional component 36. The connected part 36a of the functional component 36 is provided in a connection protruding part 36b that protrudes from part of the water path formation member 54 in the same direction as the protruding direction Pa of the casing 64. It also can be considered that the connection protruding part 36b protrudes from a lower end part of the elongate part 42 of the functional component 36. The connection part 64b of the casing 64 is provided in the base end part of the casing 64, which is located opposite to the leading end part thereof in the protruding direction Pa. This means that the casing 64 is not connected to the functional component 36 at a position other than the base end part. It also can be considered that the casing 64 is not connected to the functional component 36 at a position including the leading end part.

The cartridge 62 includes attachment parts 62a and 62b that are detachably attached to attached parts 36c and 36d of the functional component 36. The attached parts 36c and 36d of the functional component 36 are provided in the connection protruding part 36b of the water path formation member 54. The attachment parts 62a and 62b of the cartridge 62 are provided in the base end part of the cartridge 62.

The attachment parts 62a and 62b of some embodiments include a first attachment part 62a provided in a first internal water path formation member that forms the primary side internal water path 66, and a second attachment part 62b provided in a second internal water path formation member that forms the secondary side internal water path 68. In some embodiments, the first internal water path formation member is the joint member 74, and the second internal water path formation member is the housing 72.

The attached parts 36c and 36d of some embodiments include a first attached part 36c to which the first attachment part 62a is attached, and a second attached part 36d to which the second attachment part 62b is attached. The first attached part 36c is provided on an inner peripheral part of a recess part that is recessed from a leading end surface formed in the connection protruding part 36b of the functional component 36. The second attached part 36d is provided at a position in an outer peripheral part of the connection protruding part 36b, and the position is located closer to the leading end side than the connected part 36a, and the diameter at the position is smaller than that of the connected part 36a.

There will now be described the effects of the functional unit 26 set forth above. The cartridge 62 is disposed outside the receiving member 48. Accordingly, since the cartridge 62 is not disposed within the receiving member 48, a situation where the shape of the receiving member 48 is limited by the cartridge 62 can be avoided, so that flexibility in the shape of the receiving member 48 can be improved. For example, compared to the case where the cartridge 62 is disposed within the receiving member 48, the receiving member 48 can be downsized. Also, since the shape of the receiving member 48 need not be designed such that the cartridge 62 can be installed in or removed from the receiving member 48, the shape of the receiving member 48 can be designed irrespective of the cartridge 62. Since flexibility in the inner dimensions of the receiving member 48 is improved, the strength of the receiving member 48 can be easily ensured without causing increase in the outer dimensions of the receiving member 48.

The functional component 36 includes the water path formation member 54 provided separately from the receiving member 48, and the water path formation member 54 includes the attached parts 36c and 36d to which the cartridge 62 is detachably attached. Accordingly, since parts like the attached parts 36c and 36d of the water path formation member 54, which tend to be complicated, need not be provided in the receiving member 48, flexibility in the shape of the receiving member 48 can be further improved.

The water path formation member 54 is the lower bracket 52 fixed to the bathroom wall part 16. Accordingly, both the load applied to the receiving member 48 and the load applied to the water path formation member 54 during the attachment or detachment of the cartridge 62 can be transmitted to the bathroom wall part 16 via the mutual lower bracket 52. Therefore, the number of necessary parts can be reduced, compared to the case where separate brackets are used to transmit the loads to the bathroom wall part 16.

The casing 64 is detachably connected to the functional component 36. Accordingly, when the cartridge 62 is replaced, the casing 64 can also be replaced. Also, when the size of a new casing 64 is made larger, for example, the size of a new cartridge 62 can also be made larger easily. Further, a function absent in the existing casing 64 can be built in a new casing 64. The function may be displaying the life of the cartridge 62, for example. Thus, with the functional unit 26 of some embodiments, flexibility for handling replacement of the cartridge 62 can be improved.

Since the casing 64 is not directly fixed to the bathroom wall part 16, the casing 64 can be easily detached from the functional component 36. Accordingly, favorable workability in replacement of the cartridge 62 can be obtained.

The functional component 36 is fixed to the bathroom wall part 16, and the reforming unit 38 is formed integrally with the functional component 36. Accordingly, the entire functional unit 26 is disposed at a position in the air higher than the bathtub 12 and the washing place floor 14, so that the functional unit 26 is less likely to be impeditive when the bathtub 12 or the washing place floor 14 is used.

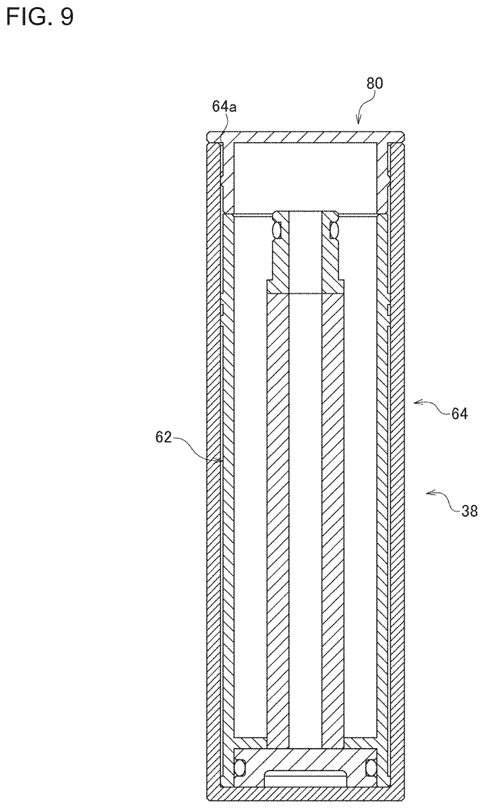

FIG. 9 is a sectional view that shows a state before the reforming unit 38 is attached to the functional component 36. According to some embodiments, the reforming unit 38 can be handled in the state where the casing 64 and the cartridge 62 of the reforming unit 38 are detached from the functional component 36. Therefore, by transporting the cartridge 62 housed in the casing 64, the cartridge 62 can be protected by the casing 64 during the transportation.

The opening 64a of the casing 64 can be closed by a lid member 80 that is detachably attached to the base end part of the casing 64. In the state where the lid member 80 is detached from the casing 64, the casing 64 and the cartridge 62 can be attached to the functional component 36.

The casing 64 is provided such as to protrude from the functional component 36, and the base end part of the casing 64 is detachably connected to the functional component 36. Accordingly, a connection position at which the casing 64 is connected to the functional component 36 is only the base end part of the casing 64. Therefore, compared to the case where there are multiple connection positions between the casing 64 and the functional component 36, man-hours required in the process of attaching or detaching the casing 64 to or from the functional component 36 can be reduced because of the reduced number of connection positions, so that workability in the attaching and detaching processes can be improved. Also, because of the reduced number of connection positions between the casing 64 and the functional component 36, a configuration required for the connection therebetween can be simplified.

The casing 64 has a bottomed cylindrical shape provided with the opening 64a that opens upward, as shown in FIG. 8. Accordingly, when the casing 64 is detached from the functional component 36, even if water is retained within the casing 64, the water is less likely to spill out of the casing 64 through the opening 64a. Therefore, when the casing 64 or the cartridge 62 is detached from the functional component 36, scattering of water therearound can be prevented, so that favorable workability can be obtained.

The casing 64 is detachably connected to the functional component 36 for receiving a load of a bathroom item 40. Accordingly, since disassembly of the functional component 36 is not required during the replacement of the cartridge 62, the state of the functional component 36 receiving the load of the bathroom item 40 can be maintained. In other words, the cartridge 62 can be replaced without changing the position of the bathroom item 40 supported by the functional component 36, so that favorable workability can be obtained.

Since the casing 64 is provided away from the bathroom wall part 16 with the space 78 in between, the space 78 can be used as a work space. Accordingly, a worker can attach or detach the casing 64 more easily by placing his or her hand in the space 78 between the casing 64 and the bathroom wall part 16, obtaining favorable workability.

The functional unit 26 of some embodiments is provided as a single unit in which the water path formation member 54 and the water path switching mechanism 56 besides the casing 64 and the cartridge 62 are integrally formed. Therefore, besides the reforming of water using the cartridge 62, switching between whether or not reforming is performed by means of the water path switching mechanism 56 can also be performed in the single unit.

Other features of the functional unit 26 will now be described. FIG. 7 is referred to. A gap between the first attached part 36c of the functional component 36 and the first attachment part 62a of the cartridge 62 is sealed by a first seal member 82. The first seal member 82 can restrict water leakage from the primary side water passage 30 or the primary side internal water path 66 to other areas. The first seal member 82 of the present embodiment can restrict the flowing of water between the primary side water passage 30 or the primary side internal water path 66 and the secondary side water passage 32 or the secondary side internal water path 68. A gap between the second attached part 36d of the functional component 36 and the second attachment part 62b of the cartridge 62 is sealed by a second seal member 84. The second seal member 84 can restrict water leakage from the secondary side water passage 32 or the secondary side internal water path 68 to other areas. Each of the seal members 82 and 84 is an elastic body, such as an O-ring.

In the base end part of the casing 64, the single opening 64a, through which the primary side water passage 30 and the secondary side water passage 32 of the water path formation member 54 pass, is provided. The water supply passage 28 of some embodiments is provided such as to pass inside the casing 64 only through the single opening 64a of the casing 64. Accordingly, besides the opening 64a, no other opening through which the water supply passage 28 passes is provided in the casing 64. It also can be considered that the water supply passage 28 is provided such that both an inward part from the outside to the inside of the casing 64 and a return part from the inside to the outside of the casing 64 pass only through the single opening 64a of the casing 64. Although the inward part in some embodiments is the primary side water passage 30 of the water path formation member 54, it may be the primary side internal water path 66 of the reforming unit 38. Also, although the return part in some embodiments is the secondary side water passage 32 of the water path formation member 54, it may be the secondary side internal water path 68 of the reforming unit 38.

If another opening is provided in the casing 64, another seal member will need to be provided between the cartridge 62 and another member so as to restrict water leakage from the other opening. According to some embodiments, however, the number of seal members used to seal gaps between the cartridge 62 and other members can be reduced, compared to the case where another opening through which the water supply passage 28 passes is provided in another area of the casing 64, so that the structure of the cartridge 62 can be simplified.

FIG. 5 is now referred to. The casing 64 may be provided such as to protrude in a direction that intersects a normal direction Pb of the bathroom wall part 16. The normal direction Pb means a direction along a normal line that passes an inner wall surface of the bathroom wall part 16. Accordingly, compared to the case where the casing 64 protrudes along the normal direction Pb, interference between the casing 64 and a bathing person or another item is less likely to occur, so that favorable usability can be obtained. From this perspective, when an angle between a directional axis of the protruding direction Pa of the casing 64 and the normal line that passes an inner wall surface of the bathroom wall part 16 is defined as θ, the angle θ may preferably be set to 45 degrees or greater. Also, the protruding direction Pa of the casing 64 may more preferably be parallel with the bathroom wall part 16. Being parallel as used herein includes, besides the case of being strictly geometrically parallel, the case of being almost parallel.

The casing 64 is provided such as to protrude in a longitudinal direction of the elongate part 42 from the functional component 36, over an extension of the elongate part 42 of the functional component 36 toward the longitudinal direction. It also can be considered that, when viewed from a longitudinal direction of the elongate part 42, the casing 64 is disposed at a position that overlaps with the elongate part 42, and is provided such as to extend in the same direction as the longitudinal direction of the elongate part 42. The casing 64 of some embodiments is provided such as to protrude from an end part of the elongate part 42 in a longitudinal direction.

This prevents the casing 64 from protruding in a direction that intersects the longitudinal direction of the elongate part 42 of the functional component 36. Accordingly, compared to the case where the casing 64 is provided such as to protrude from the functional component 36 in another direction, interference between the casing 64 and a bathing person or another item (such as the secondary side hose 24) is less likely to occur, so that favorable usability can be obtained. The outer peripheral surface of the casing 64 is provided such as to be flush with the outer peripheral surface of the elongate part 42 of the functional component 36.

In order to obtain a similar effect, as long as the casing 64 is provided such as to protrude in a longitudinal direction of the elongate part 42 of the functional component 36 over an extension toward the longitudinal direction, the casing 64 may protrude from an area other than the elongate part 42 of the functional component 36.

FIG. 7 is now referred to. In the functional component 36, a water flow outlet 30a of the primary side water passage 30 is provided, through which water flows out into the cartridge 62. The water flow outlet 30a of some embodiments opens downward. Accordingly, when the cartridge 62 is detached from the attached part 36c of the functional component 36, even if the raw water is supplied from the water faucet device 18 to the water supply passage 28 by an erroneous operation, scattering of the water therearound can be prevented, compared to the case where the water flow outlet 30a opens upward.

In the functional component 36, a water flow inlet 32a of the secondary side water passage 32 is also provided, through which water flows in from the cartridge 62. The water flow inlet 32a of some embodiments also opens downward. More specifically, each of the water flow outlet 30a and the water flow inlet 32a of some embodiments opens downward along a vertical line.

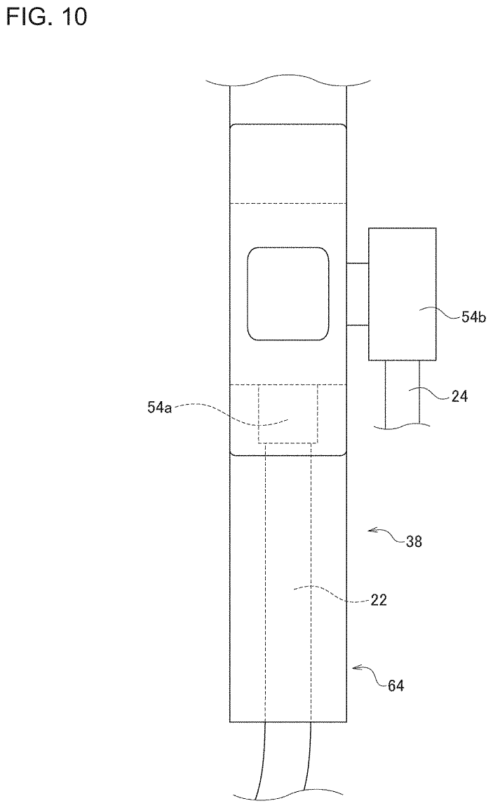

FIG. 10 is a magnified view of the peripheral structures of the reforming unit 38 shown in FIG. 3. As shown in FIGS. 5 and 10, the primary side hose 22 is disposed in the space 78 between the casing 64 and the bathroom wall part 16. When the bathroom wall part 16 is viewed from the front, the primary side hose 22 is disposed at a position that overlaps with the casing 64 behind the casing 64. Advantages thereof will be described.

It is assumed here that a bathing person or another item is in contact with the primary side hose 22, and the primary side hose 22 is about to move accidentally in the normal direction Pb of the bathroom wall part 16. At the time, the move of the primary side hose 22 can be restricted by the bathroom wall part 16 and the casing 64, so that a large move of the primary side hose 22 can be prevented. Also, since the layout is designed such that the primary side hose 22 is disposed near the bathroom wall part 16, interference between a bathing person and the primary side hose 22 is less likely to occur during use of the bathroom space, so that favorable usability can be obtained.

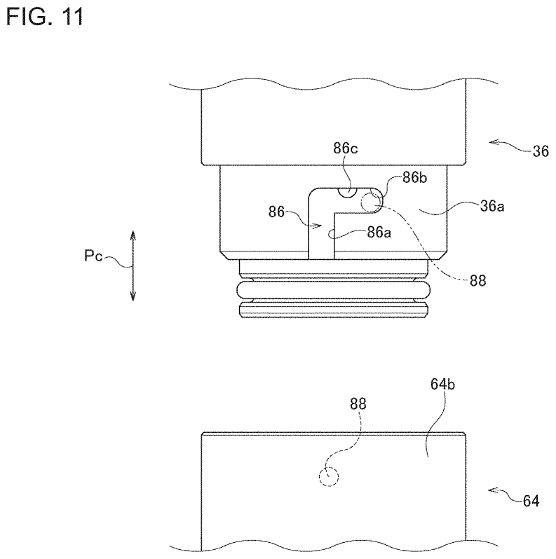

FIG. 11 is a diagram of the connected part 36a of the functional component 36 viewed from the direction of the arrow Pe shown in FIG. 7. FIG. 11 also shows the connection part 64b of the casing 64 disconnected from the functional component 36. As shown in FIGS. 7 and 11, one of the connection part 64b of the casing 64 and the connected part 36a of the functional component 36 is provided with a guide recess part 86, and the other thereof is provided with a guide projection part 88. In some embodiments, the guide recess part 86 is provided in the functional component 36, and the guide projection part 88 is provided in the casing 64. The guide recess part 86 and the guide projection part 88 in contact with each other constitute a guide mechanism that can guide the casing 64 when the casing 64 is attached to or detached from the functional component 36.

The connection part 64b of the casing 64 is guided by the guide mechanism to move in a first attaching/detaching direction Pc, so as to be attached to or detached from the connected part 36a of the functional component 36. The first attaching/detaching directions Pc in some embodiments are directions along the protruding direction Pa of the casing 64. One of the first attaching/detaching directions Pc (the downward direction in FIG. 11) is a detaching direction in which, when the casing 64 is detached from the functional component 36, the casing 64 moves. The other of the first attaching/detaching directions Pc (the upward direction in FIG. 11) is an attaching direction in which, when the casing 64 is attached to the functional component 36, the casing 64 moves.

The guide recess part 86 of some embodiments includes a first groove-shaped part 86a that extends along a first attaching/detaching direction Pc of the casing 64, and a second groove-shaped part 86b that is provided continuously with a terminal part in the attaching direction of the first groove-shaped part 86a and that extends in a circumferential direction around the connected part 36a of the functional component 36.

The connection part 64b of the casing 64 in some embodiments is moved in the attaching direction of the casing 64 and then rotated around the connected part 36a of the functional component 36, thereby being attached to the connected part 36a of the functional component 36. This is enabled by the guide provided by the guide mechanism. When the casing 64 is attached to the functional component 36, the guide projection part 88 is located within the second groove-shaped part 86b of the guide recess part 86. Accordingly, the guide projection part 88 is in contact with an inner wall surface of the second groove-shaped part 86b of the guide recess part 86, and displacement of the casing 64 in the detaching direction is restricted, so that the position of the casing 64 with respect to the functional component 36 is maintained.

Also, by rotating the connection part 64b of the casing 64 in some embodiments toward the both sides around the connected part 36a of the functional component 36, the state can be switched between a detachable state in which the casing 64 can be detached from the functional component 36 in the detaching direction, and a non-detachable state in which the casing 64 cannot be detached in the detaching direction. The guide projection part 88 is located in the terminal part of the first groove-shaped part 86a of the guide recess part 86 in the detachable state, and located within the second groove-shaped part 86b of the guide recess part 86 in the non-detachable state.

The guide recess part 86 is also provided with a stopper part 86c that restricts a move of the guide projection part 88 from the inside of the second groove-shaped part 86b into the first groove-shaped part 86a. The stopper part 86c of some embodiments is a projection part that projects from the inner wall surface of the second groove-shaped part 86b. By strongly rotating the guide projection part 88 around the connected part 36a of the functional component 36, the guide projection part 88 can be moved within the second groove-shaped part 86b, with elastic deformation of the guide projection part 88 and the stopper part 86c.

Meanwhile, the attachment parts 62a and 62b of the cartridge 62 are moved in a second attaching/detaching direction Pd, so as to be attached to or detached from the attached parts 36c and 36d of the functional component 36. The second attaching/detaching directions Pd in some embodiments are directions along the protruding direction Pa of the casing 64, i.e., the same directions as the first attaching/detaching directions Pc.

As shown in FIG. 8, the casing 64 and the cartridge 62 of some embodiments are configured such as to be attachable to the functional component 36, in the state where the cartridge 62 is housed within the casing 64. In order to achieve the configuration, the first attaching/detaching directions Pc of the casing 64 and the second attaching/detaching directions Pd of the cartridge 62 are set to the same directions in some embodiments. To be attached to the functional component 36, the casing 64 and the cartridge 62 of some embodiments are moved in the attaching direction (upward direction in FIG. 8), which is one of the attaching/detaching directions Pc or Pd, and the casing 64 is then rotated around the connected part 36a of the functional component 36.

Accordingly, in the replacement of the cartridge 62, since the attachment of the casing 64 and the attachment of the cartridge 62 need not be performed separately, favorable workability can be obtained. Also, the cartridge 62 is housed within the casing 64 before they are attached to the functional component 36. Accordingly, the casing 64 and the cartridge 62 can be attached to the functional component 36 after whether or not foreign matter is jammed between the casing 64 and the cartridge 62 is checked in hand, so that there is the advantage of facilitated recognition of foreign matter contamination.

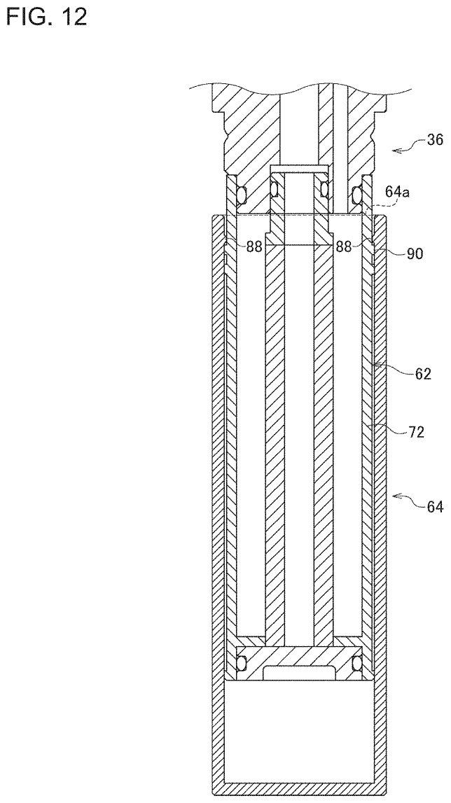

FIG. 12 is a diagram that shows a state during an operation of detaching the casing 64 from the functional component 36. In the housing 72 of the cartridge 62, a retaining part 90 is provided. The retaining part 90 of some embodiments is provided as a protrusion on an outer peripheral part of the housing 72. The retaining part 90 engages with the guide projection part 88, which functions as an engagement part in the casing 64, thereby restricting coming out of the cartridge 62 through the opening 64a of the casing 64.

When the casing 64 is to be detached from the functional component 36, the guide projection part 88 of the casing 64 engages with the retaining part 90 of the cartridge 62, so that the cartridge 62 can also be detached from the casing 64. At the time, the casing 64 and the cartridge 62 are detached from the functional component 36, in the state where the cartridge 62 is housed within the casing 64. It can be considered that the casing 64 and the cartridge 62 are configured such as to be detachable from the functional component 36, in the state where the cartridge 62 is housed within the casing 64. Accordingly, in the replacement of the cartridge 62, since the detachment of the casing 64 and the detachment of the cartridge 62 need not be performed separately, favorable workability can be obtained.

The cartridge 62 can be removed through the opening 64a of the casing 64 by strongly pulling the cartridge 62 in the direction of coming out through the opening 64a of the casing 64, with elastic deformation of the casing 64.

As shown in FIG. 6, the reforming unit 38 includes a life information display part 92 that can display life information regarding the life of the cartridge 62. Although the life information display part 92 of some embodiments is constituted by a level meter as an example, it may be constituted by another meter, a display, a lamp, or the like.

The life information may be information regarding the remaining life of the cartridge 62, for example. The remaining life information may be displayed using a ratio of an actual amount of supplied water to a predetermined reference amount of supplied water at which replacement of the cartridge 62 is assumed to be required, for example. The remaining life information may be displayed in analog or digital form using a meter, such as a pointer meter and a level meter, or may be displayed in digital form using numbers and characters, for example. Also, the life information may be information that indicates approach of the end point of the life of the cartridge 62. The information may be displayed by turning on a lamp when the actual amount of supplied water exceeds the reference amount of supplied water in the cartridge 62, for example. The amount of supplied water in the cartridge 62 may be measured using a flow rate sensor and calculated based on the measurement, for example.

The life information display part 92 is provided at a position different from that of the bar member 48 (receiving member) of the functional component 36 along which the shower hook 40 can be slid. The life information display part 92 of some embodiments is provided in part of the casing 64 such as to be visually recognized from the bathroom space. This can avoid the situation where the life information display part 92 cannot be visually recognized because of the shower hook 40 (bathroom item), so that favorable usability can be obtained.

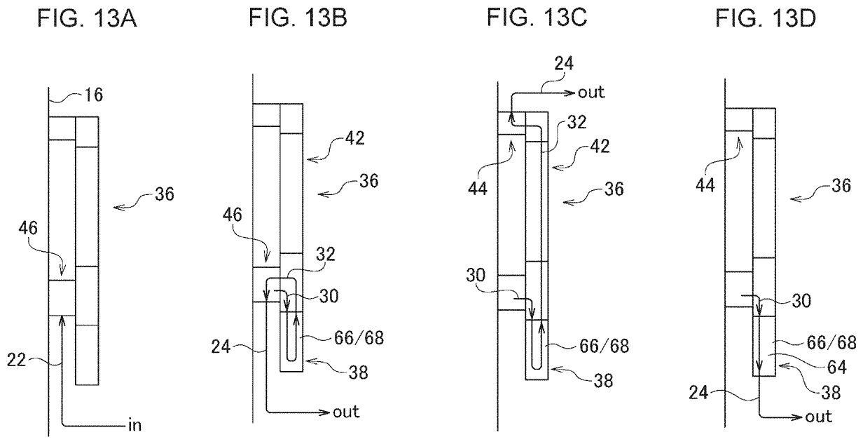

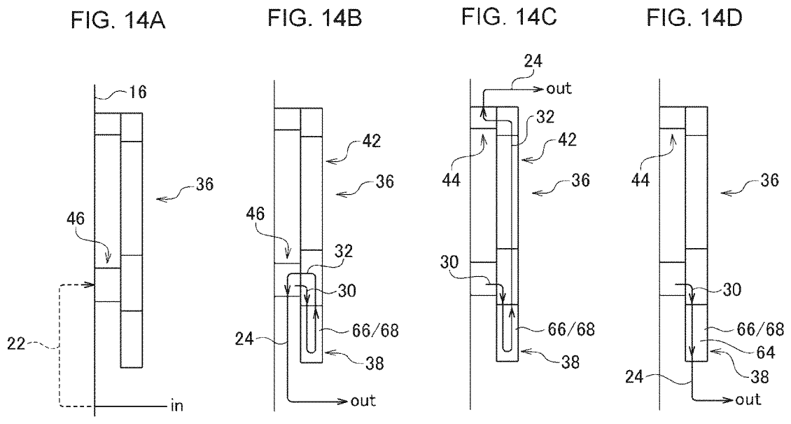

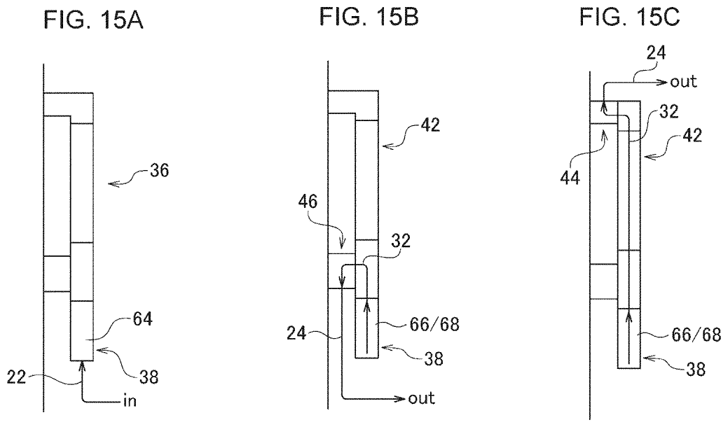

There will now be described modes of the water path used for the functional unit 26. FIGS. 13-15 are schematic diagrams that each show a position at which the primary side hose 22 or the secondary side hose 24 is connected to the functional component 36. FIG. 13A, FIG. 14A, and FIG. 15A show a connection position of the primary side hose 22, and FIGS. 13B-13D, FIGS. 14B-14D, FIG. 15B, and FIG. 15C show a connection position of the secondary side hose 24. FIG. 13A shows an example that can be combined with examples shown in each of FIG. 13B, FIG. 13C, and FIG. 13D. FIG. 14A shows an example that can be combined with examples shown in each of FIG. 14B, FIG. 14C, and FIG. 14D. FIG. 15A shows an example that can be combined with examples shown in each of FIG. 15B and FIG. 15C.

FIG. 13A shows an example in which the primary side hose 22 is connected to the lower support part 46 of the functional component 36. The primary side hose 22 is connected to the functional component 36 without passing through the back side of the bathroom wall part 16.

FIG. 13B shows an example in which the secondary side hose 24 is connected to the lower support part 46 of the functional component 36. The primary side water passage 30 in the functional unit 26 passes through the lower support part 46 and the elongate part 42 of the functional component 36. The internal water paths 66 and 68 in the reforming unit 38 are provided such as to pass through and turn back within the cartridge 62 (not illustrated). The secondary side water passage 32 in the functional unit 26 passes through the elongate part 42 and the lower support part 46 of the functional component 36.

FIG. 13C shows an example in which the secondary side hose 24 is connected to the upper support part 44 of the functional component 36. Unlike the example of FIG. 13B, the secondary side water passage 32 in the functional component 36 passes through the elongate part 42 and the upper support part 44 of the functional component 36 in this example.

FIG. 13D shows an example in which the secondary side hose 24 is connected to the casing 64 of the reforming unit 38, instead of the functional component 36. In this example, the internal water paths 66 and 68 in the reforming unit 38 are provided such as to pass straight within the cartridge 62 (not illustrated), without passing through and turning back. From the reforming unit 38, raw water or reformed water is directly supplied to the secondary side hose 24, without flowing through the functional component 36.

FIG. 14A shows an example in which the primary side hose 22 passes through the back side of the bathroom wall part 16 to be connected to the lower support part 46 of the functional component 36. FIGS. 14B-14D are similar to FIGS. 13B-13D.

FIG. 15A shows an example in which the primary side hose 22 is connected to the casing 64 of the reforming unit 38, instead of the functional component 36.

FIG. 15B shows an example in which the secondary side hose 24 is connected to the lower support part 46 of the functional component 36. In this example, the internal water paths 66 and 68 in the reforming unit 38 are provided such as to pass straight within the cartridge 62 (not illustrated), without passing through and turning back. The secondary side water passage 32 in the functional unit 26 passes through the elongate part 42 and the lower support part 46 of the functional component 36.

FIG. 15C shows an example in which the secondary side hose 24 is connected to the upper support part 44 of the functional component 36. Unlike the example of FIG. 15B, the secondary side water passage 32 in the functional component 36 passes through the elongate part 42 and the upper support part 44 of the functional component 36 in this example.

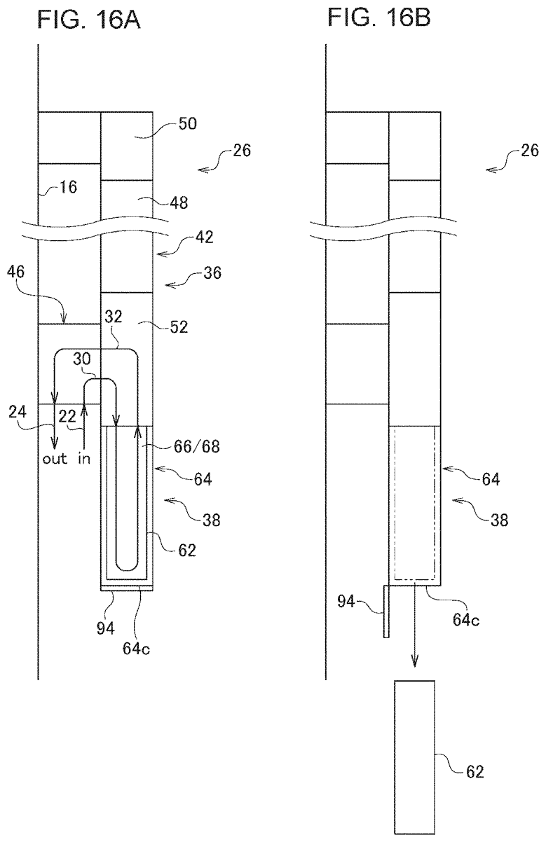

FIG. 16 is a schematic side view of the functional unit 26 in some embodiments. FIG. 16A shows a state where an opening/closing lid 94 is attached to an inlet/outlet port 64c of the casing 64, and FIG. 16B shows a state where the opening/closing lid 94 is detached from the inlet/outlet port 64c.

In the example described with reference to FIG. 4, the casing 64 of the reforming unit 38 is detachably connected to the functional component 36. Meanwhile, the casing 64 in this example is connected to the functional component 36 such as to be non-detachable. At an end part of the casing 64, the inlet/outlet port 64c used to install or remove the cartridge 62 is formed. The casing 64 is provided with the opening/closing lid 94 with which the inlet/outlet port 64c of the casing 64 can be opened and closed. When the opening/closing lid 94 is detached from the inlet/outlet port 64c such that the inlet/outlet port 64c is opened, the cartridge 62 of the reforming unit 38 can be installed or removed through the inlet/outlet port 64c of the casing 64.

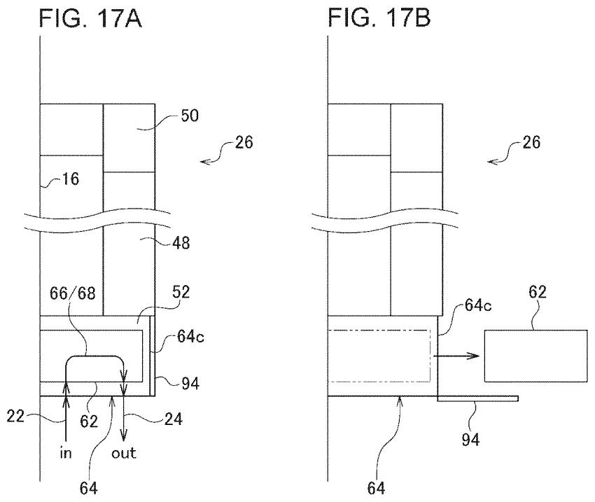

FIG. 17 is a schematic side view of the functional unit 26 in some embodiments. FIG. 17A shows a state where the opening/closing lid 94 is attached to the inlet/outlet port 64c of the casing 64, and FIG. 17B shows a state where the opening/closing lid 94 is detached from the inlet/outlet port 64c.

In the example described with reference to FIG. 4, the casing 64 of the reforming unit 38 is provided separately from the functional component 36. In some embodiments, the lower bracket 52 of the functional component 36 serves dually as the casing 64, and the casing 64 and the lower bracket 52 are configured as the same member. The casing 64 of some embodiments is directly fixed to the bathroom wall part 16 and provided such as not to be separated from the functional component 36. The casing 64 of some embodiments is also provided with the opening/closing lid 94 with which the inlet/outlet port 64c of the casing 64 can be opened and closed. Thus, the casing 64 may be constituted by the same member as a constituting member of the functional component 36.

Exemplary embodiments and modifications of the present disclosure have been described in detail. Each of the abovementioned embodiments and modifications merely describes a specific example for carrying out embodiments of the present disclosure. The embodiments and modifications are not intended to limit the technical scope of the present disclosure, and various design modifications, including changes, addition, and deletion of constituting elements, may be made to the embodiments or modifications without departing from the scope of ideas of the disclosure. In the aforementioned embodiments, matters to which design modifications may be made are emphasized with the expression of “embodiment”, but design modifications may also be made to matters without such expression. Optional combinations of the abovementioned constituting elements may also be employed as additional modes of the present disclosure. Also, the hatching provided on the cross sections in the drawings is not provided to limit the materials of the objects with the hatching.

The “function” of the functional component 36 is receiving a load of a bathroom item 40 or a bathing person in the example described above. The bathroom item 40 is not limited to the shower hook, and may be a shower head, a bathtub lid, a hose, or the like. Each of these items is regarded as a bathroom item 40 that is movable with respect to the bathroom wall part 16. The functional component 36 will be a shower hook if it receives the load of a shower head, will be a bathtub lid hook if it receives the load of a bathtub lid, and will be a hose hook if it receives the load of a hose. Also, if the “function” of the functional component 36 is receiving the load of a bathing person, the functional component 36 may also be a simple handrail or the like besides the slide bar. Also, the “function” of the functional component 36 is a function related to a bathroom and has only to be a function other than reforming water, and the specific example thereof is not limited to the aforementioned example. The functional component 36 may be regarded as a fixed component that implements such a function and is fixed to a bathroom wall part directly or via another member.

The elongate part 42 and the bar member 48 of the functional component 36 are not particularly limited with regard to the extending directions thereof, and may be provided such as to extend along a horizontal direction. Although part of the elongate part 42 of the functional component 36 is constituted by the bar member 48 in the example described above, the entire elongate part 42 may be constituted by the bar member 48. Also, although the support parts 44 and 46 of the functional component 36 are constituted by the brackets 50 and 52 in the example described above, the support parts 44 and 46 may be constituted by the bar member 48. In this case, the receiving member 48 constituted by the bar member 48 will be directly fixed to the bathroom wall part 16 without the intervention of support members. Although the receiving member is the bar member 48 in the example described above, the specific example thereof is not particularly limited. For example, the receiving member may be a table for a washbowl, a bathroom shelf, or the like for receiving the load of a bathroom item.

The water path formation member 54 of the functional component 36 need not be provided with the water path switching mechanism 56. Each of the water flow outlet 30a of the primary side water passage 30 and the water flow inlet 32a of the secondary side water passage 32 in the water path formation member 54 opens downward along a vertical line in the example described above. Alternatively, each of the water flow outlet 30a and the water flow inlet 32a may open downward such as to be greatly inclined with respect to a vertical line, or may open upward.

The cartridge 62 is entirely housed within the casing 64 in the example described above. Alternatively, at least part of the cartridge 62 may be housed, and such part may be housed within the functional component 36. Further, the cartridge 62 may be disposed outside the receiving member, or may be housed within a member different from the receiving member of the functional component 36.

Although the cartridge 62 has an elongate shape extending in the protruding direction Pa of the casing 64 in the example described above, the shape of the cartridge 62 is not particularly limited. Also, although the casing 64 is provided separately from the housing 72 of the cartridge 62 in the example described above, the casing 64 may serve dually as the housing 72.

As a mode of reforming of raw water in the cartridge 62, although purification of raw water has been described as an example, the mode is not limited thereto. For example, the mode may be addition of a beauty component, a fragrant component, a carbonate component, or a hydrogen component.

Although the casing 64 is provided such as to protrude from the functional component 36 in the example described above, the configuration is not limited thereto. Also, even when the casing 64 is provided such as to protrude from the functional component 36, the casing 64 may be connected to the functional component 36 at multiple positions other than the base end part. Further, an opening through which the water supply passage 28 passes may be provided at a position different from the base end part in the casing 64.

In order to obtain favorable usability, the casing 64 in the example described above protrudes downward in a longitudinal direction of the elongate part 42 from the functional component 36, over an extension of the elongate part 42 of the functional component 36. For the purpose of obtaining such an effect, if the elongate part 42 extends in a vertical direction, the casing 64 may protrude upward in a longitudinal direction of the elongate part 42 from the functional component 36.

In the example described above, the casing 64 is provided away from the bathroom wall part 16 with the space 78 in between. The casing 64 has only not to be directly fixed to the bathroom wall part 16, and may be in contact with the bathroom wall part 16 or the functional component 36. Also, in the space 78, the secondary side hose 24, instead of the primary side hose 22, may be disposed.

Although the first attaching/detaching directions Pc of the casing 64 are directions along the protruding direction Pa of the casing 64 in the example described above, the first attaching/detaching directions Pc may be set irrespective of the protruding direction Pa of the casing 64. Also, in the example described above, the casing 64 is moved in a first attaching/detaching direction Pc of the casing 64 and rotated around the connected part 36a of the functional component 36, thereby being attached to or detached from the functional component 36. However, the casing 64 only has to be attachable or detachable when moved in a first attaching/detaching direction Pc, and whether or not the casing 64 is rotated or whether or not other movement is required is not particularly specified.

In the example described above, the casing 64 and the cartridge 62 are configured such as to be attachable to and detachable from the functional component 36, in the state where the cartridge 62 is housed within the casing 64. However, the cartridge 62 and the casing 64 may be separately attachable to the functional component 36, and may be separately detachable from the functional component 36.

In order to configure the casing 64 and the cartridge 62 to be integrally detached from the functional component 36, a combination of the retaining part 90 and the engagement part is used in the example described above; however, a specific means therefor is not particularly limited. For example, the cartridge 62 may be press-fitted into the casing 64, or a lock mechanism for locking the cartridge 62 in the casing 64 may be used.

In the example described above, the casing 64 is detachably connected to the functional component 36 by means of the guide mechanism constituted by the guide recess part 86 and the guide projection part 88; however, the specific structure for the detachable connection is not particularly limited. For example, the casing 64 may be detachably connected using snap fitting or magnetic force, or using screws or clips.

With regard to the functional unit for a bathroom in some embodiments, the casing may be provided such as to protrude from the functional component, and a base end part of the casing may be detachably connected to the functional component. In this mode, compared to the case where there are multiple connection positions between the casing and the functional component, workability in the process of attaching or detaching the casing to or from the functional component can be improved because of the reduced number of connection positions.

With regard to the functional unit for a bathroom in some embodiments, the base end part may be provided with an opening through which the water supply passage passes, and the water supply passage may be provided such as to be gotten in or out of the casing only through the opening. In this mode, the number of seal members used to seal gaps between the cartridge and other members can be reduced, compared to the case where another opening through which the water supply part passes is provided in another area of the casing, so that the structure of the cartridge can be simplified.

With regard to the functional unit for a bathroom in some embodiments, the casing may be provided such as to protrude in a direction that intersects a normal direction of the bathroom wall part. In this mode, compared to the case where the casing protrudes along the normal direction, interference between the casing and a bathing person or another item is less likely to occur, so that favorable usability can be obtained.

With regard to the functional unit for a bathroom in some embodiments, the functional component may include an elongate part, and the casing may be provided such as to protrude in a longitudinal direction of the elongate part from the functional component, over an extension of the elongate part toward the longitudinal direction. In this mode, compared to the case where the casing is provided such as to protrude from the functional component in another direction, interference between the casing and a bathing person or another item is less likely to occur, so that favorable usability can be obtained.

With regard to the functional unit for a bathroom in some embodiments, the casing may have a bottomed cylindrical shape provided with an opening that opens upward. In this mode, when the casing is detached from the functional component, even if water is retained within the casing, the water is less likely to spill out of the casing through the opening.

With regard to the functional unit for a bathroom in some embodiments, the casing and the cartridge may be configured such as to be attachable to the functional component, in a state where the cartridge is housed within the casing. In this mode, in the replacement of the cartridge, since the attachment of the casing and the attachment of the cartridge need not be performed separately, favorable workability can be obtained.

With regard to the functional unit for a bathroom in some embodiments, the casing and the cartridge may be configured such as to be detachable from the functional component, in a state where the cartridge is housed within the casing. In this mode, in the replacement of the cartridge, since the detachment of the casing and the detachment of the cartridge need not be performed separately, favorable workability can be obtained.

With regard to the functional unit for a bathroom in some embodiments, the functional component may be provided to receive a load of a bathroom item or a bathing person.

With regard to the functional unit for a bathroom in some embodiments, the casing may be disposed away from the bathroom wall part with a space in between. In this mode, a worker can attach or detach the casing more easily by placing his or her hand in the space between the casing and the bathroom wall part, obtaining favorable workability.

With regard to the functional unit for a bathroom in some embodiments, a hose connected to the functional component may be disposed in the space. In this mode, an accidental move of the hose can be restricted by the bathroom wall part and the casing, so that a large move of the hose can be prevented.

With regard to the functional unit for a bathroom in some embodiments, the functional component may include a primary side water passage provided on the upstream side of the cartridge in the water supply passage, and a water flow outlet of the primary side water passage, through which water flows out into the cartridge, may open downward. In this mode, when the cartridge is detached from the functional component, even if the raw water is supplied from the water faucet device to the water supply passage by an erroneous operation, scattering of the water therearound can be prevented, compared to the case where the water flow outlet opens upward.

With regard to the functional unit for a bathroom in some embodiments, the functional component may include a water path formation member, in which part of the water supply passage is formed, provided separately from the receiving member, and the water path formation member may include an attached part to which the cartridge is detachably attached. In this mode, since parts like the attached parts of the water path formation member, which tend to be complicated, need not be provided in the receiving member, flexibility in the shape of the receiving member can be further improved.

With regard to the functional unit for a bathroom in some embodiments, the water path formation member may be a bracket fixed to the bathroom wall part. In this mode, both the load applied to the receiving member and the load applied to the water path formation member during the attachment or detachment of the cartridge can be transmitted to the bathroom wall part via the mutual lower bracket. Therefore, the number of necessary parts can be reduced, compared to the case where separate brackets are used to transmit the loads to the bathroom wall part.

With regard to the functional unit for a bathroom in some embodiments, the receiving member may be a bar member.

With regard to the functional unit for a bathroom in some embodiments, the reforming unit may include a casing that houses the cartridge, the functional component may include an elongate part, at least part of which is constituted by the bar member, and the casing may be provided such as to protrude in a longitudinal direction of the elongate part from the functional component, over an extension of the elongate part toward the longitudinal direction. In this mode, compared to the case where the casing is provided such as to protrude from the functional component in another direction, interference between the casing and a bathing person or another item is less likely to occur, so that favorable usability can be obtained.

With regard to the functional unit for a bathroom in some embodiments, the reforming unit may include a casing that houses the cartridge, and the casing may be provided such as to protrude in a direction that intersects a normal direction of the bathroom wall part. In this mode, compared to the case where the casing protrudes along the normal direction, interference between the casing and a bathing person or another item is less likely to occur, so that favorable usability can be obtained.

With regard to the functional unit for a bathroom in some embodiments, the reforming unit may include a life information display part capable of displaying life information of the cartridge, and the life information display part may be provided at a position different from that of the receiving member. In this mode, the situation where the life information display part cannot be visually recognized because of the bathroom item can be avoided, so that favorable usability can be obtained.

With regard to the functional unit for a bathroom in some embodiments, the reforming unit may include a casing that houses the cartridge, the casing may be disposed away from the bathroom wall part with a space in between, and a hose connected to the functional component may be disposed in the space. In this mode, an accidental move of the hose can be restricted by the bathroom wall part and the casing, so that a large move of the hose can be prevented.

With regard to the functional unit for a bathroom in some embodiments, the functional component may include a primary side water passage provided on the upstream side of the cartridge in the water supply passage, and a water flow outlet of the primary side water passage, through which water flows out into the cartridge, may open downward. In this mode, when the cartridge is detached from the functional component, even if the raw water is supplied from the water faucet device to the water supply passage by an erroneous operation, scattering of the water therearound can be prevented, compared to the case where the water flow outlet opens upward.

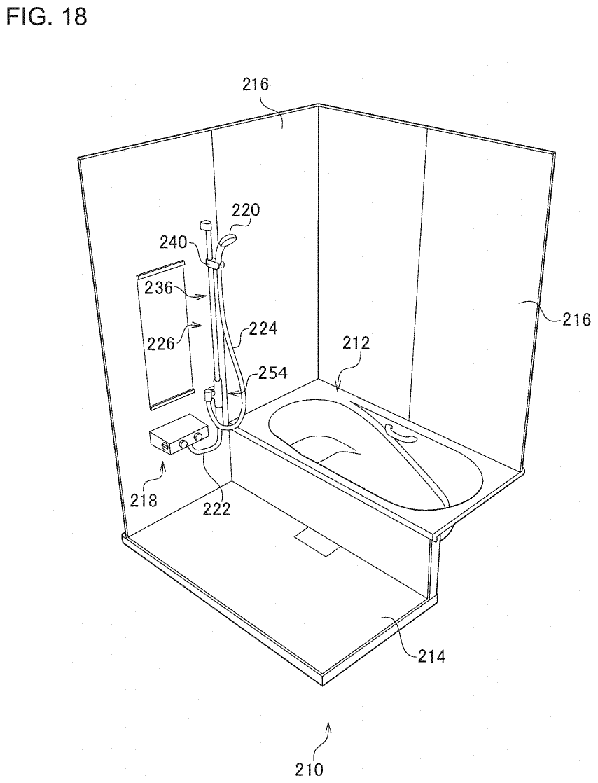

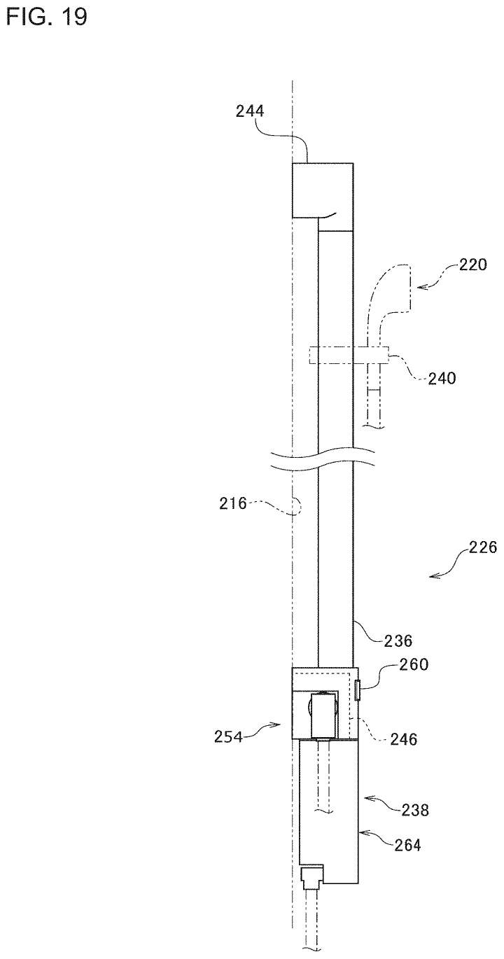

FIG. 18 is a perspective view of a bathroom unit 210 in some embodiments. FIG. 19 is a side view of a functional unit 226. The bathroom unit 210 includes a bathtub 212, a washing place floor 214 provided at a position adjacent to the bathtub 212, multiple bathroom wall parts 216 that define a bathroom space therein, a water faucet device 218, a water discharge device 220, a primary side hose 222, a secondary side hose 224, and a functional unit 226.

The water faucet device 218 adjusts the flow rate or temperature of water discharged from the water discharge device 220, based on an operation performed by a bathing person.

The functional unit 226 includes a slide bar 236 as a functional component for a bathroom, support members 244 and 246 for supporting the slide bar 236, and a raw water reforming device 254 (reforming unit) for reforming raw water. The slide bar 236 receives a load of a shower hook 240 or a bathing person, and slidably supports the shower hook 240. The slide bar 236 is provided separately from the water faucet device 218. On the shower hook 240, the water discharge device 220, which is a shower head, is hooked.

The support members 244 and 246 are fixed to a bathroom wall part 216 by means of fixtures, such as screws. The slide bar 236 of some embodiments extends in a vertical direction, an upper end part thereof is supported by the bathroom wall part 216 via the support member 244, and a lower end part thereof is supported by the bathroom wall part 216 via the support member 246. Based on an operation performed by a bathing person on the operation member 260, the raw water reforming device 254 switches the water to supply between raw water and reformed water and supplies the water to the water discharge device 220.

The primary side hose 222 connects the water faucet device 218 and the raw water reforming device 254, and the secondary side hose 224 connects the raw water reforming device 254 and the water discharge device 220.

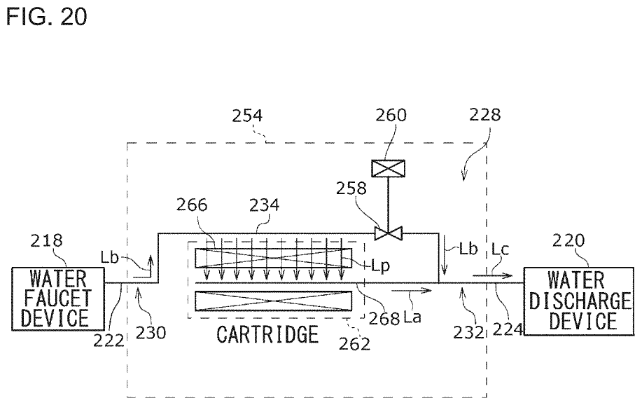

FIG. 20 is a diagram that shows a water supply passage 228 from the water faucet device 218 to the water discharge device 220. On the water supply passage 228, a cartridge 262 and a valve mechanism 258 of the raw water reforming device 254 are provided. The cartridge 262 reforms raw water supplied to a primary side peripheral surface part 266 and supplies the water to a secondary side internal water path 268. The water supply passage 228 includes a primary side water passage 230, a secondary side water passage 232, and a raw water passage 234, which are provided in the raw water reforming device 254. To the raw water passage 234, raw water Lb is supplied through the primary side hose 222 via the primary side water passage 230. When the valve mechanism 258 is placed in an open state, the raw water Lb within the raw water passage 234 is supplied as supply water Lc to the secondary side hose 224 via the valve mechanism 258 and the secondary side water passage 232. When the valve mechanism 258 is placed in a closed state, the raw water Lb within the raw water passage 234 is reformed to reformed water La in the cartridge 262 to be supplied as the supply water Lc to the secondary side hose 224 via the secondary side water passage 232.

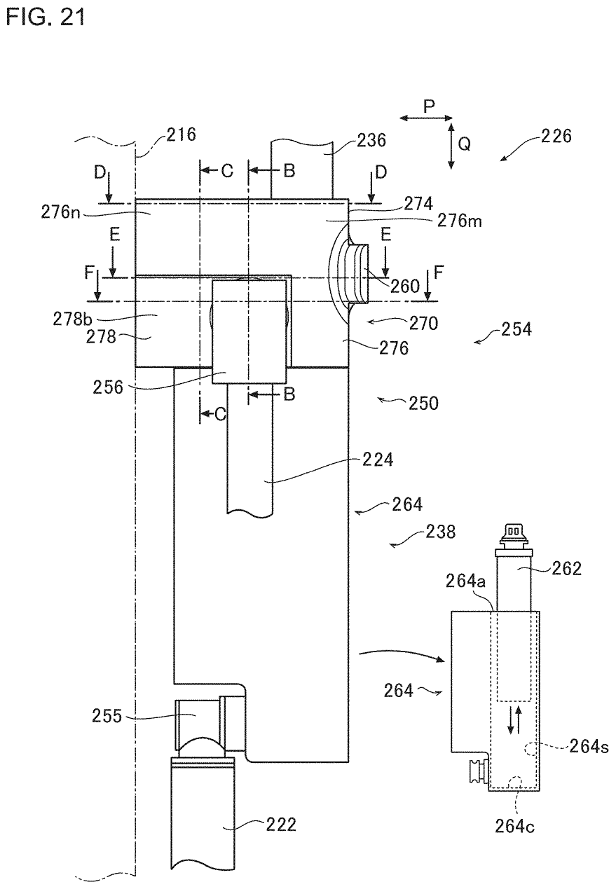

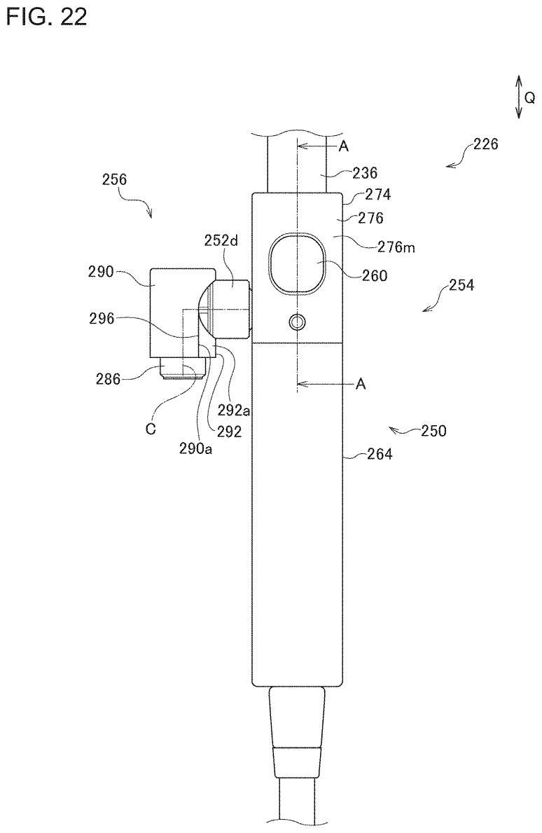

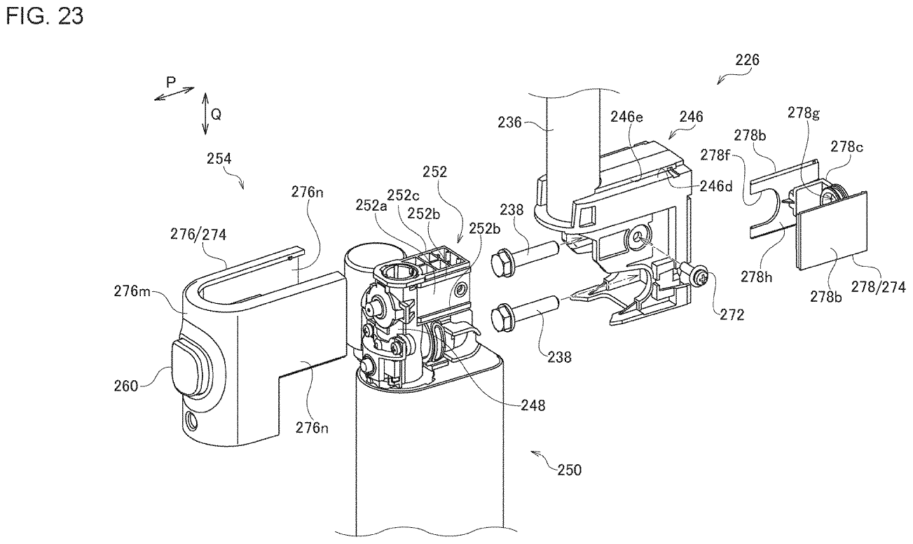

FIG. 21 is a left side view of the raw water reforming device 254 and the vicinity thereof. FIG. 22 is a front view of the raw water reforming device 254 and the vicinity thereof. FIG. 23 is an exploded perspective view of the raw water reforming device 254 and the vicinity thereof.

In the following, normal directions of the bathroom wall part 216 will be referred to as directions P, and vertical directions will be referred to as directions Q, for the sake of convenience. In some embodiments, a direction P and a direction Q are perpendicular to each other. Also, a direction perpendicular to a direction P and a direction Q may be referred to as a left or right direction.

The raw water reforming device 254 is formed integrally with the slide bar 236. The raw water reforming device 254 includes a device main body 250 (unit main body) and a cover 274. The device main body 250 includes a water path formation body 252, the cartridge 262, a casing 264 for housing the cartridge 262, a first hose connection part 255 to which the primary side hose 222 is connected, and a second hose connection part 256 to which the secondary side hose 224 is connected.

The first hose connection part 255 is provided in a lower part of the casing 264. The second hose connection part 256 is provided in a left side surface part of the water path formation body 252. In the first hose connection part 255, the aforementioned primary side water passage 230 is formed, and, in the water path formation body 252 and the second hose connection part 256, the aforementioned secondary side water passage 232 is formed.

The water path formation body 252 includes a switching mechanism part 248. The switching mechanism part 248 opens or closes the valve mechanism 258 (not illustrated in FIGS. 21-23) based on an operation performed on the operation member 260, thereby switching the supply water Lc between the raw water Lb and the reformed water La.

The casing 264 is detachably attached to another member of the raw water reforming device 254, which is the lower part of the water path formation body 252 in some embodiments. The casing 264 includes a housing part 264s provided to house the cartridge 262. An upper end of the casing 264 is provided with an opening 264a, and a lower end thereof is closed. The cartridge 262 is installed or removed through the opening 264a. As shown in FIG. 21, the internal space in the housing part 264s constitutes the aforementioned raw water passage 234 around the cartridge 262. The primary side water passage 230 formed in the first hose connection part 255 communicates with the internal space in the housing part 264s through an opening formed on the rear side of the lower part of the casing 264.

The raw water reforming device 254 is provided separately from the support member 246 and fixed to the support member 246 by means of a fixture 272, such as a screw. If the raw water reforming device 254 is provided integrally with the support member 246 as one component, a dedicated raw water reforming device needs to be prepared for each type of the slide bar 236 as a functional component for a bathroom, so that the cost will be increased. On the other hand, when the raw water reforming device 254 is provided separately from the support member 246 and fixed to the support member 246, as described in some embodiments, the raw water reforming device 254 can be shared as long as a dedicated support member 246 is prepared for each type of the slide bar 236, so that the cost can be reduced.

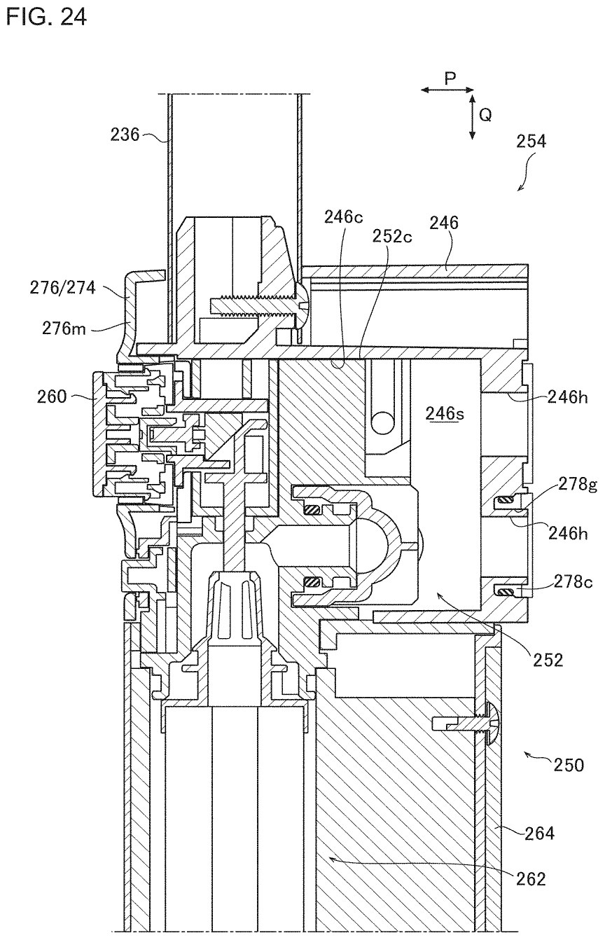

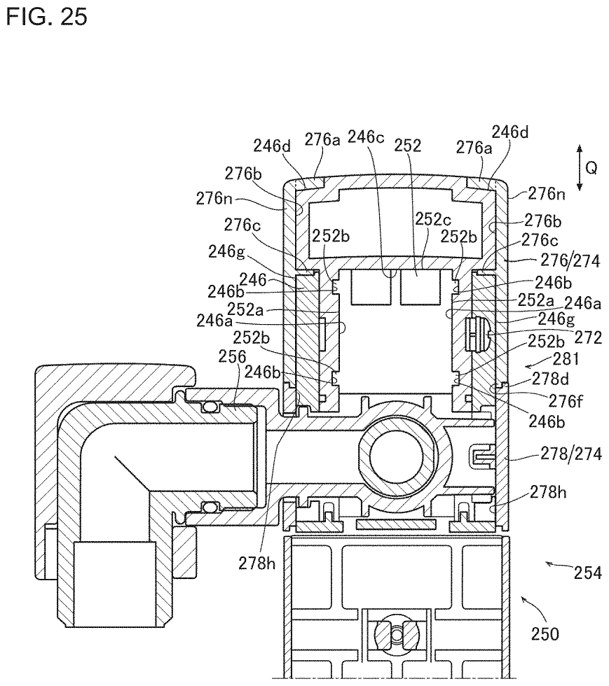

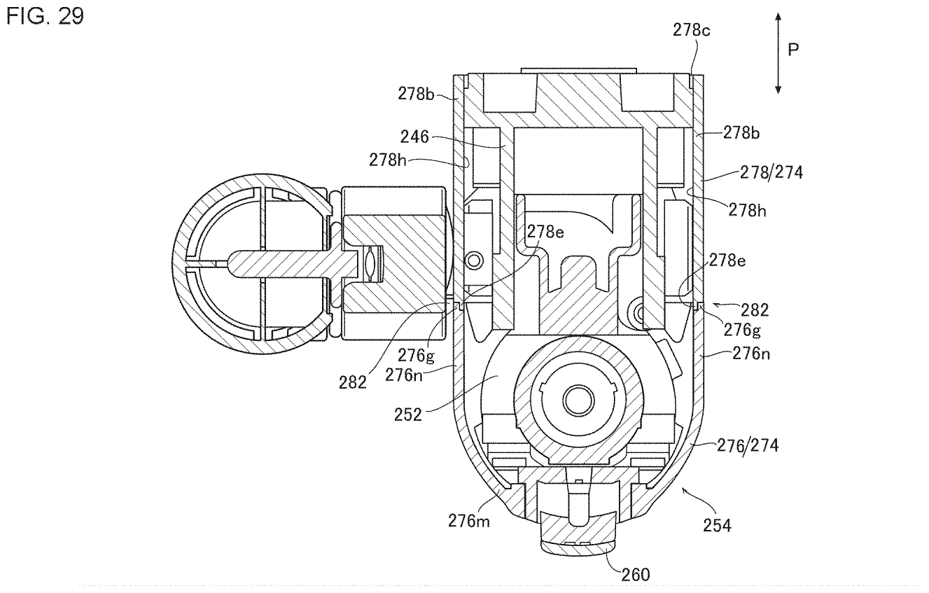

FIG. 24 is a sectional view taken along line A-A in FIG. 22. Also, FIGS. 25-29 are sectional views taken along lines B-B, C-C, D-D, E-E, and F-F in FIG. 21, respectively.

As shown in FIG. 24, for example, the water path formation body 252 is housed in a housing space 246s within the support member 246. In the support member 246, an insertion hole 246h is formed behind the water path formation body 252. A fixture 238 is inserted into the insertion hole 246h, and the support member 246 is fixed to the bathroom wall part 216 by means of the fixture 238 behind the water path formation body 252 housed in the housing space 246s. This can reduce the dimension in a vertical direction of a portion of the raw water reforming device 254 protruding from the support member 246, thereby achieving neat appearance.

As shown in FIG. 25, for example, the raw water reforming device 254 is supported by the support member 246 by means of a slide fitting structure. In some embodiments, two protrusions 252b extending along forward and backward directions are formed on each of left and right side surfaces 252a of the water path formation body 252, and two grooves 246b extending along forward and backward directions are formed on each of inner wall surfaces 246a of the support member 246, which respectively face the left and right side surfaces 252a of the water path formation body 252. The water path formation body 252 is slid in a horizontal direction such that the protrusions 252b are inserted into the grooves 246b, so that the water path formation body 252 is housed in the housing space 246s of the support member 246. The protrusions 252b, or the raw water reforming device 254, is supported by the inner peripheral surfaces of the grooves 246b. In this case, by making the protrusions 252b and grooves 246b relatively long, the contact areas (support areas) therebetween can be made larger and the support spans can be made longer, so that the vertical load of the raw water reforming device 254 can be firmly supported by the support member 246. The protrusions may be formed on the support member 246, and the grooves may be formed on the water path formation body 252.

The support member 246 includes the inner wall surfaces 246a that face the left and right side surfaces 252a of the water path formation body 252, as described previously. The inner wall surfaces 246a restrict leftward and rightward moves or rotation of the water path formation body 252, or of the raw water reforming device 254. The support member 246 also includes a top surface 246c that faces an upper surface 252c of the water path formation body 252. The top surface 246c and the grooves 246b, into which the protrusions 252b are inserted, restrict upward and downward moves or rotation of the water path formation body 252, or of the raw water reforming device 254. Thus, wobbling of the raw water reforming device 254 can be restrained.

The left and right side surfaces 252a of the water path formation body and the left and right inner wall surfaces 246a of the support member 246 preferably have complementary shapes, or have corresponding shapes, or, yet in other words, have substantially identical cross-sectional shapes. Similarly, the upper surface 252c of the water path formation body 252 and the top surface 246c of the support member 246 preferably have complementary shapes. Accordingly, when a load is applied to the water path formation body 252, the support member 246 can receive the load on a surface thereof. This can restrain a large load being locally applied to the water path formation body 252 and the support member 246, thereby also restraining abrasion, deformation, damage, or the like thereof.

As shown in FIGS. 21-23 and 25, the cover 274 covers the water path formation body 252 including the support member 246. Since the cover 274 covers the fixture 238, favorable appearance can be ensured while the raw water reforming device 254 can be firmly fixed to the support member 246 by means of the fixture 238. The cover 274 of some embodiments includes a first cover body 276 and a second cover body 278. In the illustrated example, the first cover body 276 covers the fixture 238.

The first cover body of some embodiments includes a first portion 276m that covers the front surface and part of the both side surfaces of the water path formation body 252, and second portions 276n that each cover another part of one of the both side surfaces of the water path formation body 252. The first portion 276m has a substantially half-cylindrical shape curved to form a frontward convex. The second portions 276n have plate shapes that extend backward respectively from the both end parts of the first portion 276m. The dimension in a vertical direction of the second portion 276n is substantially half the dimension in a vertical direction of the first portion 276m. The first cover body 276 has a vertically-long rectangle shape when viewed from the front, and has an inverted L shape when viewed from a side.

As shown in FIGS. 23 and 25-27, the first cover body 276 includes, at an upper end part thereof, an overhang part 276a that overhangs inward. Also, on an inner wall surface 276b of the first cover body 276, which faces the both side surfaces of the support member 246, two protrusions 276c extending along forward and backward directions are formed. The two protrusions 276c are positioned lower than the overhang part 276a. At both the left and right ends of the upper surface of the support member 246, recess parts 246d are formed such as to extend along forward and backward directions and to be recessed downward. The first cover body 276 is slid in a horizontal direction from the front side of the support member 246 such that the overhang part 276a and the protrusions 276c vertically sandwich an upper portion of the support member 246, so that the first cover body 276 is fitted to the support member 246.

Portions of the overhang part 276a overhanging from the second portions 276n are housed respectively in the recess parts 246d. Such portions of the overhang part 276a are formed such that the interval W1 therebetween becomes wider toward the rear side. Similarly, the recess parts 246d of the support member 246 are configured such that the interval W2 between peripheral wall surfaces 246e becomes wider toward the rear side. Accordingly, when the first cover body 276 is fitted to the support member 246, sliding of the overhang part 276a and the recess parts 246d can be restrained, so that the fitting condition of the first cover body 276 can be improved.

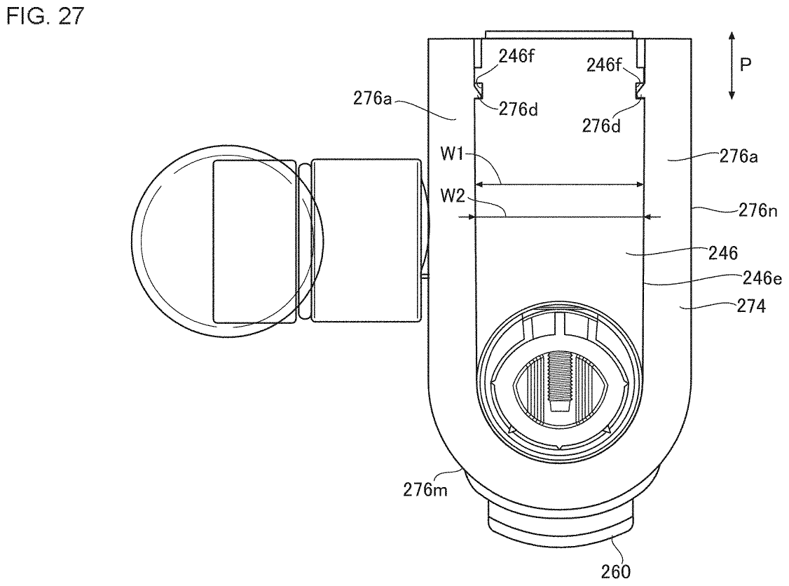

As shown in FIG. 27, in the first cover body 276, clicks 276d protruding toward left and right inner sides are formed in the rear side of the overhang part 276a. Meanwhile, in the upper rear side of the support member 246, recess parts 246f corresponding to the clicks 276d are formed such as to be recessed toward left and right inner sides. The clicks 276d are engaged with the recess parts 246f.

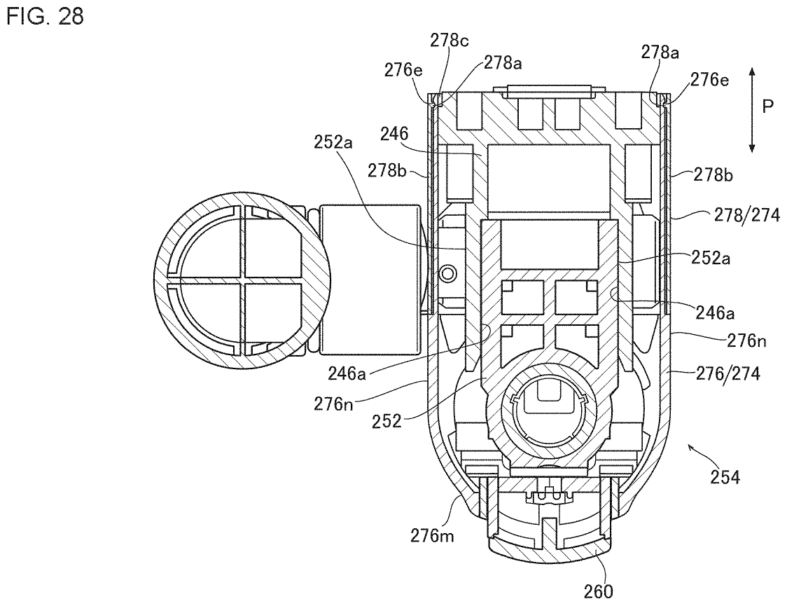

As shown in FIG. 28, in the lower rear side of the first cover body 276, recess parts 276e recessed toward left and right inner sides are formed. Meanwhile, in the upper rear side of the second cover body 278, clicks 278a corresponding to the recess parts 276e are formed such as to protrude toward left and right inner sides. The clicks 278a are engaged with the recess parts 276e.

The engagement between the clicks 276d and the recess parts 246f as shown in FIG. 27 is released by widening the upper side of the first cover body 276, and the engagement between the clicks 278a and the recess parts 276e as shown in FIG. 28 is released by narrowing the lower side of the first cover body 276. In other words, the first cover body 276 can be detached by inversely deforming the upper side and the lower side of the first cover body 276. This can restrain accidental detachment of the first cover body 276.

As shown in FIGS. 21 and 23, for example, the second cover body 278 includes a pair of cover parts 278b that cover a portion of the left and right side surfaces 252a of the water path formation body 252, which is not covered with the first cover body 276, and a connection part 278c that connects the pair of cover parts 278b. Each cover part 278b has a plate shape. Since the pair of cover parts 278b are configured integrally as one component, necessary parts can be reduced, so that the cost can also be reduced. In one of the cover parts 278b, a cutout 278f, into which the second hose connection part 256 is inserted, is formed. Instead of the cutout 278f, an insertion hole may be formed.

As shown in FIGS. 21 and 24, for example, in the connection part 278c of the second cover body 278, an insertion hole 278g, into which a fixture is inserted, is formed. The second cover body 278 is fixed (jointly screwed, for example) together with the support member 246 to the bathroom wall part 216 by means of the fixture 238. Accordingly, compared to the case where the second cover body 278 and the support member 246 are fixed to the bathroom wall part 216 by means of separate fixtures, necessary parts can be reduced, so that the cost can also be reduced.

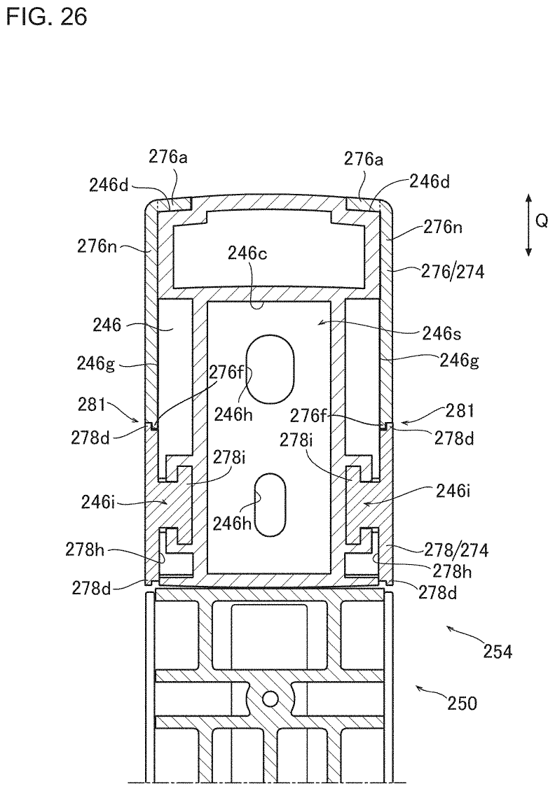

As shown in FIGS. 23 and 26, for example, the second cover body 278 and the support member 246 are provided with positioning structures for positioning the second cover body 278. On each of left and right side surfaces 246g of the support member 246, an engagement recess part 246i is provided. On each of facing surfaces 278h of the cover parts 278b, which face the left and right side surfaces 246g of the support member 246, an engagement projection part 278i is provided. The second cover body 278 is slid in a horizontal direction from the rear side of the support member 246 such that the engagement projection parts 278i are engaged with the engagement recess parts 246i, so that the second cover body 278 is fitted to the support member 246. Accordingly, the second cover body 278 is vertically positioned. Also, upward and downward moves of the second cover body 278 are restricted. The engagement projection parts may be formed on the support member 246, and the engagement recess parts may be formed on the second cover body 278.

The second cover body 278 has an angulate U shape in plan view, though the illustration thereof is omitted. The engagement projection parts 278i described above are also connected to the connection part 278c besides the cover parts 278b. Accordingly, the engagement projection parts 278i also function as reinforcement parts for restraining deformation of the U-shaped second cover body 278. Also, the second cover body 278 may be provided with reinforcement parts, such as ribs, separately from the engagement projection parts 278i.

As shown in FIGS. 21, 25, 26, and 29, for example, the first cover body 276 and the second cover body 278 are joined together at two parts of a first joint part 281, and a second joint part 282 that extends in a direction intersecting the first joint part 281. In the illustrated example, the first joint part 281 is perpendicular to the second joint part 282. More specifically, the first joint part 281 extends along forward and backward directions, and the second joint part 282 extends along upward and downward directions.

The first joint part 281 extending along forward and backward directions between the first cover body 276 and the second cover body 278 is configured such as to restrict outward tilting of the first cover body 276 (in other words, to restrict inward tilting of the second cover body 278). Also, the second joint part 282 extending along upward and downward directions between the first cover body 276 and the second cover body 278 is configured such as to restrict inward tilting of the first cover body 276 (in other words, to restrict outward tilting of the second cover body 278). Accordingly, each of the first cover body 276 and the second cover body 278 is restricted for both the inward tilting and the outward tilting. The first joint part 281 may be configured such as to restrain inward tilting of the first cover body 276, and the second joint part 282 may be configured such as to restrain outward tilting of the first cover body 276.

In the first joint part 281 of some embodiments, step parts having complementary shapes are formed respectively on end surfaces of the first cover body 276 and the second cover body 278. More specifically, step parts 276f, which become higher (or are positioned lower) toward the inner side on both the left and right sides, are formed on the first cover body 276, and step parts 278d, which become higher toward the outer side on both the left and right sides, are formed on the second cover body 278. Accordingly, the second cover body 278 restricts outward tilting of the first cover body 276, while the first cover body 276 restricts inward tilting of the second cover body 278.

Similarly, also in the second joint part 282 of some embodiments, step parts having complementary shapes are formed respectively on end surfaces of the first cover body 276 and the second cover body 278. More specifically, step parts 276g, which become higher (or are positioned more posteriorly) toward the outer side on both the left and right sides, are formed on the first cover body 276, and step parts 278e, which become higher (or are positioned more anteriorly) toward the inner side, are formed on the second cover body 278. Accordingly, the second cover body 278 restricts inward tilting of the first cover body 276, while the first cover body 276 restricts outward tilting of the second cover body 278.

Thus, since the inward tilting and outward tilting of both the first cover body 276 and the second cover body 278 is restricted, the outer surfaces of the first cover body 276 and the second cover body 278 can be kept substantially flush with each other, so that favorable appearance can be ensured.

Also, since the two joint parts extend such as to intersect, as describe previously, rotation of each cover body is also restricted, so that a situation where a cover body is rotated to come off can be prevented.

As described above, the first cover body 276 and the second cover body 278 are slid respectively in opposite horizontal directions to be fitted to the support member 246 and, as a result, the step parts of the joint parts between the first cover body 276 and the second cover body 278 are fitted to each other. In other words, the first cover body 276 and the second cover body 278 are slid to be fitted to each other.

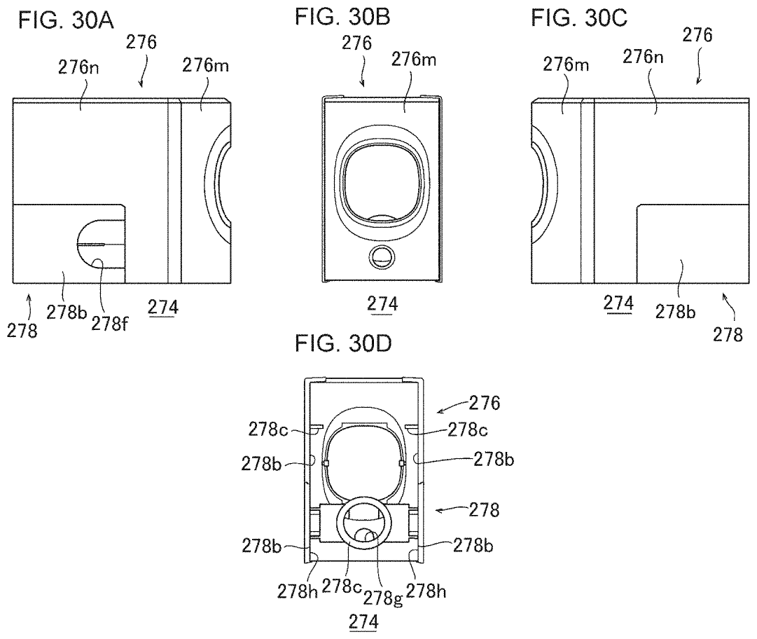

FIGS. 30A-30D are a left side view, a front view, a right side view, and a rear view of the cover 274, respectively. As shown in FIGS. 22, 23, and 25-30, the first cover body 276 is formed to be bilaterally symmetric. The second cover body 278, except for the cutout 278f formed in one of the cover parts 278b, is formed to be 180-degree rotationally symmetric (twofold symmetric) about a predetermined axis extending forward and backward from the center of the first cover body 276. Also, the second cover body 278 is formed to be vertically symmetric. Accordingly, as shown in FIGS. 25 and 26, in the second cover body 278, step parts 278d are also formed on the lower end surfaces to which the first cover body 276 is not j oined. Also, in the second cover body 278, the clicks 278a protruding toward left and right inner sides are also formed in the lower rear side to which the first cover body 276 is not joined, though the illustration thereof is omitted.

In some embodiments, the second hose connection part 256 is provided in the left side surface 252a of the water path formation body 252; however, as a modification, the second hose connection part 256 may be provided in the right side surface 252a of the water path formation body 252. In other words, the water path formation body 252 and the second hose connection part 256 may be horizontally reversed, compared to the illustrated example.

As described above, since the first cover body 276 is formed to be bilaterally symmetric and the second cover body 278 is formed to be 180-degree rotationally symmetric, when the second hose connection part 256 is provided in the right side surface 252a of the water path formation body 252, the second cover body 278 can be horizontally reversed to be attached, such that the cover part 278b provided with the cutout 278f is located on the right side. Accordingly, the second cover body 278 can be mutually used in both the case where the second hose connection part 256 is provided on the left side of the water path formation body 252 and the case where the second hose connection part 256 is provided on the right side of the water path formation body 252, so that the cost can be reduced.

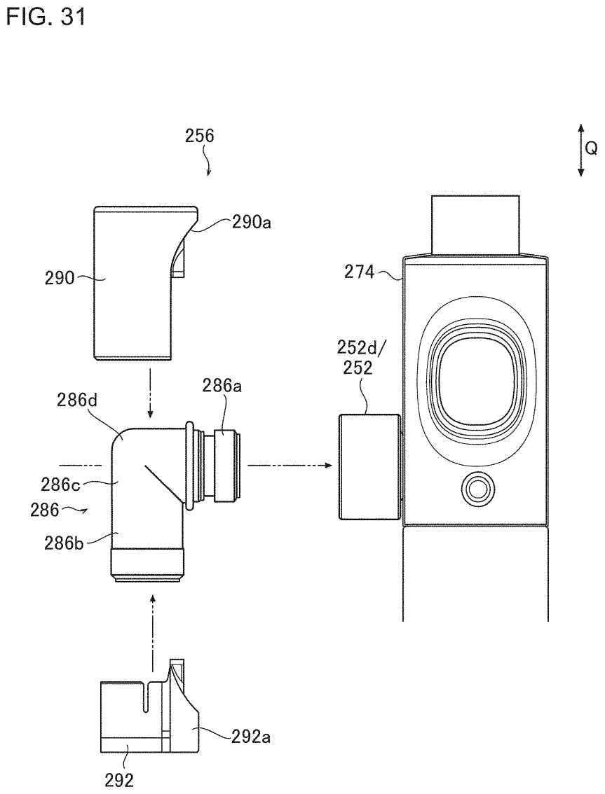

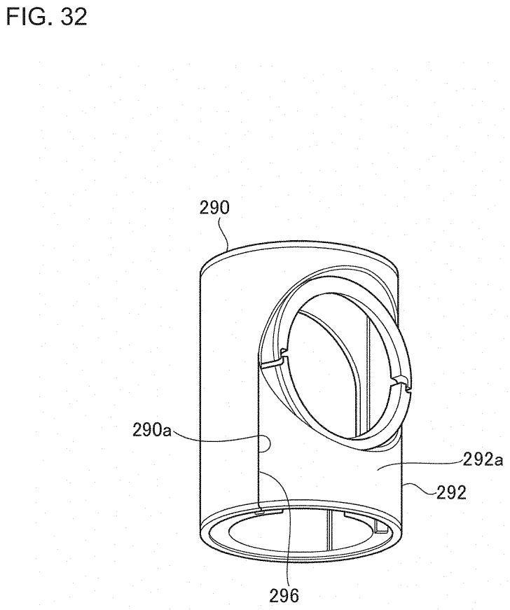

FIG. 31 is an exploded perspective view of the second hose connection part 256 and the vicinity thereof. The second hose connection part 256 includes an elbow pipe 286, a cover 290, and a retaining member 292. FIG. 32 is a perspective view of the cover 290. FIGS. 22, 23, 31, and 32 will now be referred to.

The elbow pipe 286 is made of resin, and one end thereof is connected to a protruding pipe part 252d of the water path formation body 252 protruding from the cover 274, and the other end thereof is connected to the secondary side hose 224 (not illustrated in FIGS. 22, 25, 31, and 32).

The elbow pipe 286 includes a first pipe part 286a provided such as to protrude from the water path formation body 252, a second pipe part 286b extending in a direction substantially perpendicular to the first pipe part 286a, and a connection part 286c that connects the first pipe part 286a and the second pipe part 286b. In some embodiments, the first pipe part 286a extends leftward from the water path formation body 252, and the second pipe part 286b extends vertically downward from the connection part 286c.

The cover 290 is configured to cover at least an angle part 286d of the connection part in the elbow pipe 286. Accordingly, irrespective of the appearance of the elbow pipe 286, favorable design properties can be ensured by the cover 290. In consideration of the design properties, the outer surface of the cover 290 may be plated. The cover 290 of some embodiments has a cylindrical shape of which one end side is closed, and covers the second pipe part 286b and the connection part 286c in the state where the closed part faces upward. In the cover 290, a cutout 290a, through which the first pipe part 286a protrudes, is formed.

The retaining member 292 is engaged with the cover 290 such that the retaining member 292 and the cover 290 encase the elbow pipe 286. More specifically, the cover 290 is provided to cover the elbow pipe 286 from above, and the retaining member 292 is provided from below, into which the elbow pipe 286 is inserted, to be engaged with the cover 290. Since the cover 290 and the retaining member 292 engage with each other, particularly such that the cover 290 and the retaining member 292 encase the elbow pipe 286, coming off of the cover from the elbow pipe can be restricted. Naturally, coming off of the retaining member 292 can also be restrained.

The retaining member 292 includes a cover part 292a that covers the cutout 290a of the cover 290. The cover 290 and the cover part 292a of the retaining member 292 are formed such as to be substantially flush with each other. A boundary 296 between the cover 290 and the retaining member 292 is positioned closer to the inner side of the bend than a central axis line C of the elbow pipe. In other words, the retaining member 292 is exposed only in the area closer to the inner side of the bend than the central axis line C of the elbow pipe 286. Accordingly, the elbow pipe 286 is not exposed from the cutout 290a, and the boundary 296 between the cover 290 and the retaining member 292 is indistinctive, so that the design properties can be improved.

In some embodiments, the slide bar as a functional component for a bathroom is considered as a bar member 236; however, the slide bar may be considered as a combination of the bar member 236 and the support members 244 and 246. In this case, it is considered that the support member 246 supports another constituting component (bar member 236) of the functional component for a bathroom. Also, in this case, it is considered that the casing 264 is detachably connected to the support member 246 of the functional component via another member (water path formation body 252) of the raw water reforming device 254.

Embodiments herein are intended to be illustrative only, and it will be obvious to those skilled in the art that various modifications to a combination of constituting elements could be developed and that such modifications also fall within the scope of the present disclosure.

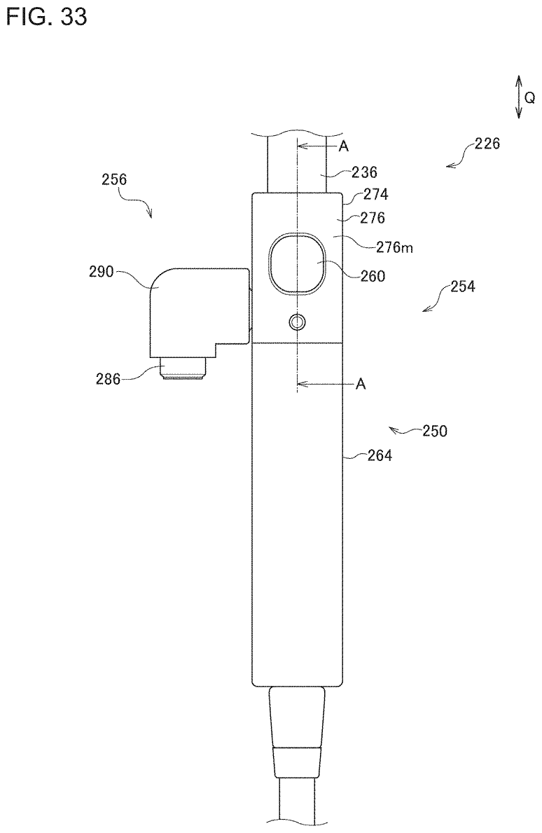

In some embodiments, provided is a case where the cover 290 is configured to cover the second pipe part 286b and the connection part 286c of the elbow pipe 286; however, the configuration is not limited thereto, and the cover may be configured to cover at least the angle part 286d of the elbow pipe 286, as described previously. FIG. 33 shows the cover 290 of a modification as an example. FIG. 33 corresponds to FIG. 22. In the modification, the cover 290 is configured to cover the first pipe part 286a besides the second pipe part 286b and the connection part 286c.

In some embodiments, provided is a case where the functional unit 226 includes a slide bar, although the configuration is not limited thereto. For example, the functional unit 226 may include a simple handrail instead of a slide bar, and the support members 244 and 246 may support the handrail. The support members 244 and 246 have only to support a functional component for a bathroom that implements a function related to a bathroom (such as a function to receive a load of a bathroom item or a bathing person).

In some embodiments, the “function” of the functional component for a bathroom is receiving a load of a bathroom item or a bathing person. Although the bathroom item has been described using a shower hook as an example, it may be a shower head, a bathtub lid, a hose, or the like. The functional component will be a shower hook if it receives the load of a shower head, will be a bathtub lid hook if it receives the load of a bathtub lid, and will be a hose hook if it receives the load of a hose. When the functional component receives the load of a bathing person, the functional component may be a simple handrail or the like besides the slide bar. Also, the “function” of the functional component is a function related to a bathroom and has only to be a function other than reforming water, and the specific example thereof is not limited to the aforementioned example. The functional component may be regarded as a fixed member that implements such a function and is fixed to a bathroom wall part directly or via another member.

The embodiment describes a technical idea of restraining the inward tilting and outward tilting of the cover 274 of the raw water reforming device 254; however, the technical idea is not limited to the raw water reforming device 254 and is also applicable to another device provided with multiple cover bodies that cover a member in which a water path is formed.

Optional combinations of the aforementioned embodiment and modifications may also be practiced as additional embodiments of the present disclosure. Such an additional embodiment made by combination has the effect of each of the combined embodiment and modifications. It will be obvious to those skilled in the art that the function to be achieved by each constituent feature described in the claims may be implemented by each of the constituting elements described in the embodiment or modifications, or by the cooperation of those constituting elements.

In some embodiments, a functional unit for a bathroom includes a support member that is fixed to a bathroom wall part and that supports a functional component for a bathroom, and a raw water reforming device that reforms raw water and that is provided separately from the support member and fixed to the support member.

In this mode, the raw water reforming device can be shared as long as a dedicated support member is prepared for each functional component for a bathroom, so that the cost can be reduced.

Part of the raw water reforming device may be housed in a housing space within the support member.

The support member may be fixed to the bathroom wall part behind the part of the raw water reforming device housed in the housing space.

In these cases, the dimension in a vertical direction of a portion of the raw water reforming device protruding from the support member can reduced, so that neat appearance can be achieved.

The raw water reforming device may include a device main body and a cover. The device main body may be fixed to the support member by means of a fixture, and the cover may be attached to the device main body such as to cover the fixture.

In this case, favorable appearance can be ensured while the raw water reforming device can be firmly fixed to the support member by means of the fixture.

The raw water reforming device may be supported by the support member by means of a slide fitting structure. In this case, the vertical load of the raw water reforming device can be firmly supported by the support member.

The support member may be configured such as to restrict a move in a horizontal direction of the raw water reforming device.

The support member may be configured such as to restrict a move in a vertical direction of the raw water reforming device.

In these cases, wobbling of the raw water reforming device can be restrained.

The raw water reforming device may include a switching mechanism part that switches supply water between raw water and reformed water, and a casing that houses a cartridge. The switching mechanism part may be fixed to the support member, and the casing may be attachable to or detachable from another member of the raw water reforming device.

The present disclosure relates to a functional unit for a bathroom, provided with a functional component for a bathroom.

1. A functional unit for a bathroom comprising:
a functional component for a bathroom, the functional component being separated from a water faucet device and fixed to a bathroom wall part; and
a reforming unit that is formed integrally with the functional component and includes a cartridge capable of reforming raw water flowing through a water supply passage from the water faucet device to a water discharge device,
wherein the reforming unit includes a casing that houses the cartridge, and the casing is detachably connected to the functional component.

2. The functional unit for a bathroom of claim 1, wherein the casing is provided such as to protrude from the functional component, and a base end part of the casing is detachably connected to the functional component.

3. The functional unit for a bathroom of claim 2, wherein the base end part is provided with an opening through which the water supply passage passes, and the water supply passage is provided such as to pass inside the casing only through the opening.

4. The functional unit for a bathroom of claim 2, wherein the casing is provided such as to protrude in a direction that intersects a normal direction of the bathroom wall part.

5. The functional unit for a bathroom of claim 2, wherein the functional component includes an elongate part, and the casing is provided such as to protrude in a longitudinal direction of the elongate part from the functional component, over an extension of the elongate part toward the longitudinal direction.

6. The functional unit for a bathroom of claim 1, wherein the casing has a bottomed cylindrical shape provided with an opening that opens upward.

7. The functional unit for a bathroom of claim 1, wherein the casing and the cartridge are configured such as to be attachable to the functional component, in a state where the cartridge is housed within the casing.

8. The functional unit for a bathroom of claim 1, wherein the casing and the cartridge are configured such as to be detachable from the functional component, in a state where the cartridge is housed within the casing.

9. The functional unit for a bathroom of claim 1, wherein the functional component is provided to receive a load of a bathroom item or a bathing person.

10. The functional unit for a bathroom of claim 1, wherein the casing is disposed away from the bathroom wall part with a space in between.

11. The functional unit for a bathroom of claim 10, wherein, in the space, a hose connected to the functional component is disposed.

12. The functional unit for a bathroom of claim 1, wherein the functional component includes a primary side water passage provided on the upstream side of the cartridge in the water supply passage, and a water flow outlet of the primary side water passage, through which water flows out into the cartridge, opens downward.

13. The functional unit for a bathroom of claim 1, wherein:
the functional component for a bathroom includes a receiving member that receives a load of a bathroom item or a bathing person; and
the cartridge is disposed outside the receiving member.

14. The functional unit for a bathroom of claim 13, wherein the functional component includes a water path formation member, in which part of the water supply passage is formed, provided separately from the receiving member, and the water path formation member includes an attached part to which the cartridge is detachably attached.

15. The functional unit for a bathroom of claim 14, wherein the water path formation member is a bracket fixed to the bathroom wall part.

16. The functional unit for a bathroom of claim 13, wherein the receiving member is a bar member.

17. The functional unit for a bathroom of claim 16, wherein the reforming unit includes a casing that houses the cartridge, the functional component includes an elongate part, at least part of which is constituted by the bar member, and the casing is provided such as to protrude in a longitudinal direction of the elongate part from the functional component, over an extension of the elongate part toward the longitudinal direction.

18. The functional unit for a bathroom of claim 13, wherein the reforming unit includes a casing that houses the cartridge, and the casing is provided such as to protrude in a direction that intersects a normal direction of the bathroom wall part.

19. The functional unit for a bathroom of claim 13, wherein the reforming unit includes a life information display part capable of displaying life information of the cartridge, and the life information display part is provided at a position different from that of the receiving member.

20. The functional unit for a bathroom of claim 13, wherein the reforming unit includes a casing that houses the cartridge the casing is disposed away from the bathroom wall part with a space in between, and, in the space, a hose connected to the functional component is disposed.

21. The functional unit for a bathroom of claim 13, wherein the functional component includes a primary side water passage provided on the upstream side of the cartridge in the water supply passage, and a water flow outlet of the primary side water passage, through which water flows out into the cartridge, opens downward.

22. The functional unit for a bathroom of claim 1, wherein the functional component for a bathroom includes a support member that is fixed to the bathroom wall part and that supports another constituting component of the functional component for a bathroom, and the reforming unit is provided separately from the support member and fixed to the support member.

23. The functional unit for a bathroom of claim 22, wherein part of the reforming unit is housed in a housing space within the support member.

24. The functional unit for a bathroom of claim 23, wherein the support member is fixed to the bathroom wall part behind the part of the reforming unit housed in the housing space.

25. The functional unit for a bathroom of claim 22, wherein the reforming unit includes a unit main body and a cover, the unit main body is fixed to the support member by means of a fixture, and the cover is attached to the unit main body such as to cover the fixture.

26. The functional unit for a bathroom of claim 22, wherein the reforming unit is supported by the support member by means of a slide fitting structure.

27. The functional unit for a bathroom of claim 22, wherein the support member is configured such as to restrict a move in a horizontal direction of the reforming unit.

28. The functional unit for a bathroom of claim 22, wherein the support member is configured such as to restrict a move in a vertical direction of the reforming unit.

29. The functional unit for a bathroom of claim 22, wherein the reforming unit includes a switching mechanism part that switches supply water between raw water and reformed water, the switching mechanism part is fixed to the support member, and the casing is attachable to or detachable from another member of the reforming unit.
